(19) United States
(12) Patent Application Publication
(10) Pub. No.: US 2026/0042935 A1
(43) Pub. Date: Feb. 12, 2026

(54) ROOFING ADHESIVE SYSTEMS AND METHODS

(71) Applicant: Seaman Corporation, Wooster, OH (US)

(72) Inventors: Warren William Gerhardt, Spartanburg, SC (US); Paul Roe, Grainger, IN (US); Jason Michael Spruell, Wooster, OH (US)

(21) Appl. No.: 19/297,697

(22) Filed: Aug. 12, 2025

Related U.S. Application Data
(60) Provisional application No. 63/681,978, filed on Aug. 12, 2024.

(51) Int. Cl. C09J 5/06; C09J 133/10

(52) U.S. Cl. CPC C09J 5/06; C09J 133/10; C09J 2203/346; C09J 2301/50; C09J 2427/00; C09J 2433/00; C09J 2463/00

(57) ABSTRACT

Disclosed herein is an adhesive formulation for adhering polyvinyl chloride (PVC) to non-PVC surfaces. The formulation includes two or more resin components. It includes a solvent for dissolving the two or more resin components. The adhesive formulation, once applied to the PVC, allows substantial evolution of hydrochloric acid (HCl) from the adhesive formulation at temperatures equal to or greater than 150° C.

### FIELD OF DISCLOSURE

This disclosure relates to methods, assemblies, systems, formulations, and synthesis of materials that can adhere portions of roofing. In particular, the disclosure relates to formulations of adhesives that improve the adhesion of roofing components made from different material types, e.g., those that improve adherence of polymeric roofing components to metal roofing components. The disclosure also relates to designs, installation, and maintenance of roofing systems that employ such adhesives and/or similar adhesives.

### BACKGROUND

Modern roofing systems tend to employ components made from a wide array of materials having different properties tailored for different purposes and functions. For example, some components are added principally to provide structural integrity to the roof. These components may incorporate various metals including steel. Other materials may be incorporated into the roof for other purposes, such as to provide protection from moisture and/or the elements. Examples include waterproofing and/or channels created to direct water away from water-sensitive portions of the roof. These latter components may be made from water-resistant or waterproof materials, such as roofing membranes made of polymeric and/or woven materials. Still other materials may be added to the roof to provide thermal (or other) insulation. These insulating roof portions may include fiberglass and other materials.

Adhering different roofing components together to form a coherent and cohesive structure is important to create a roof with structural integrity, weatherproofing, and energy efficiency, among other things. Some key issues in forming, installing, and creating such a roofing structure appear below.

Structural Integrity: Integrating structural components, such as trusses, beams, and decking, with roofing materials requires careful planning and coordination to ensure the roof can support the weight of the components and withstand environmental loads such as wind, snow, and seismic forces.

Compatibility: Ensuring compatibility between different roofing materials can prevent chemical reactions, degradation, or failure of the roofing system over time. Compatibility issues can arise when using materials with dramatically different properties or when installing new components over existing ones.

Adhesion: Robust and reliable adhesion between roofing components is important for preventing water infiltration, air leakage, and structural damage. Issues with adhesion can occur due to improper surface preparation, inadequate bonding agents, or environmental factors such as temperature and humidity.

Waterproofing: Waterproofing membranes can be important components of roofing systems that prevent water penetration and protect an underlying building's interior. Issues with waterproofing can result from improper installation, poor seam sealing, or damage to the membrane during construction or maintenance activities.

Thermal Insulation: Thermally insulating portions of the roof help regulate the temperature inside the building and improve energy efficiency. Issues with insulation can arise from inadequate thickness, improper installation, compression, or gaps that allow heat transfer and compromise thermal performance.

Addressing these issues requires careful materials selection and application. One critical aspect is the method and materials used to fasten and adhere different roofing components together to form a coherent structure. Traditional roofing systems use a combination of fasteners, such as screws, and chemical adhesives. However, application of such systems can be tricky. Even installation and handling can lead to problems, especially when mistakes are made. For example, applying typical roof fasteners may require puncturing or creating holes in the roofing membrane. Such holes or punctures can leave the entire roof structure and building vulnerable to water infiltration and damage if they are not properly sealed. Each individual point of seal, which typically accompanies each individual fastener, is a roof portion that can be vulnerable to compromise, tear, and rupture.

### SUMMARY

Given the above, it would be advantageous to develop an adhesive for a roofing system that minimizes potential for breaches of the membrane when adhering roof portions together. Such a system should also be relatively straightforward to assemble and deploy, thus minimizing potential for error and breach of structural integrity.

Disclosed herein is an adhesive formulation for adhering polyvinyl chloride (PVC) to non-PVC surfaces. The formulation includes two or more resin components and a solvent for dissolving the two or more resin components. The adhesive formulation, once applied to the PVC or alloyed PVC, allows substantial evolution of hydrochloric acid (HCl) from the VC monomer containing adhesive formulation at temperatures equal to or greater than 150° C.

The substantial evolution of HCl may be due to dehydrochlorination caused by heating the adhesive formulation. The heating may occur at a temperature of 100° C. or less. The heating may occur at a temperature of 95° C. or less. The heating may occur at a temperature of substantially 93° C. The heating may occur for 5 minutes or less. The heating may occur for 1 minute or less.

The substantial evolution of HCl may be sufficient to accelerate curing of the two or more resins. The substantial evolution of HCl may be insufficient to cause degradation of the PVC. Insufficient to cause degradation of the PVC may include that the HCl may not cause substantial browning of the PVC. The substantial evolution of HCl may include allowing some of the stoichiometrically available HCl to evolve from the VC monomer containing adhesive. When applied, the adhesive formulation may bond PVC to metal such that separating the bonded PVC and metal may require applying a tensile pull-out force of at least 400 lbs. When applied, the adhesive formulation may bond PVC to metal such that separating the bonded PVC and metal may require applying a tensile pull-out force of at least 600 lbs. When applied, the adhesive formulation may bond PVC to metal such that separating the bonded PVC and metal may require applying a tensile pull-out force of at least 800 lbs. When applied, the adhesive formulation may bond PVC to metal such that separating the bonded PVC and metal may require applying a tensile pull-out force greater than the tensile pull-out force required to separate from the metal a fastener that has been driven through the metal.

One of the two or more resin components may include an acrylic copolymer. The acrylic copolymer may have an acid number ≥7.5. The acrylic copolymer may have a glass transition temperature (T_{g}) greater than 20° C. T_{g} of the acrylic copolymer may be less than 50° C. The acrylic copolymer may have a molecular weight greater than 50,000. The acrylic copolymer may have a molecular weight less than 150,000. The acrylic copolymer may be Elvacite 418.

One of the two or more resin components may be a terpolymer. The terpolymer may be based on at least one of vinyl chloride, vinyl acetate, maleic acid, and maleic anhydride. The terpolymer may be a terpolymer of vinyl chloride, vinyl acetate, and maleic acid. The terpolymer may include Union Carbide Allyl Methacrylate resin (UCAR VMCA), Vinyl Chloride Vinyl Acetate Copolymer Resin (VMCC), Vinyl Methacrylate Copolymer resin (VMCH), or similar analogs. The terpolymer may be MC-39.

One of the two or more resin components may be derived from reacting bisphenol A and epichlorohydrin. The resin component that may be derived from reacting bisphenol A and epichlorohydrin may be Epon 828. The solvent may include a ketone. The ketone may include at least one of acetone, methyl ethyl ketone (MEK, C₄H₈O), and methyl isobutyl ketone (MIBK, (CH₃)₂CHCH₂C(O)CH₃). The ketone may include at least one of cyclohexanone (C₆H₁₀O) and isophorone (C₉H₁₄O). The solvent may include an ether-based solvent. The ether-based solvent may include at least one of tetrahydrofuran (THF, (CH₂)₄O), diethyl ether ((C₂H₅)₂O), dioxane (C₄H₈O₂), bis(2-methoxyethyl) ether (C₆H₁₄O₃), ethylene glycol dimethyl ether (C₆H₁₄O₃), and tetrahydropyran (THP, C₅H₁₀₀). The solvent may include an aromatic solvent. The aromatic solvent may include toluene. The aromatic solvent may include a xylene. The xylene may include at least one of ortho-xylene, meta-xylene, and para-xylene.

One of the two or more resin components may be Elvacite 4188. One of the two or more resin components may be MC-39. One of the two or more resin components may be Epon 828. The solvent may include at least one of a ketone, aromatic solvent, ester-based solvent, and ether-based solvent. A concentration of Elvacite 4188 by volume in the adhesive formulation may be between 25 and 35%. A concentration of MC-39 by volume in the adhesive formulation may be between 2.5 and 12.5%. A concentration of Epon 828 by volume in the adhesive formulation may be between 0.5 and 2.5%. A concentration of solvent by volume in the adhesive formulation may be between 50 and 70%. At least one of: the concentration of Elvacite 4188 by volume in the adhesive formulation may be between 28 and 32%, the concentration of MC-39 by volume in the adhesive formulation may be between 7.0 and 8.0%, the concentration of Epon 828 by volume in the adhesive formulation may be between 1.25 and 1.75%, and the concentration of solvent by volume in the adhesive formulation may be between 55 and 65%. The adhesive formulation may be used to adhere components of a roof. The adhesive formulation may be used to adhere a membrane to the roof. The adhesive formulation may be used to adhere the membrane to an induction plate in the roof.

Disclosed herein is a roof that includes components adhered together using the adhesive formulation described above. The adhesive formulation may be used to adhere a membrane to the roof. The adhesive formulation may be used to adhere the membrane to an induction plate in the roof. The adhesive formulation may be coated on the membrane. The adhesive formulation may be coated on the induction plate. The membrane may include PVC. The substantial evolution of HCl may be due to dehydrochlorination caused by heating the VC (Vinyl Chloride) monomer containing adhesive formulation to a temperature of 100° C. or less. The solvent may include at least one of an acrylic copolymer, a ketone, an aromatic solvent, an ester-based solvent, and an ether-based solvent. The two or more resin components may include at least one of an acrylic copolymer, VC containing terpolymer, and a component derived from reacting bisphenol A and epichlorohydrin. The adhesive formulation may bond the membrane to the induction plate such that separating the bonded membrane and induction plate may require applying a tensile pull-out force of at least 600 lbs.

Disclosed herein is a method of applying an adhesive formulation for adhering polyvinyl chloride (PVC), PVC containing, or PVC alloy to a non-PVC surface. The method includes dissolving two or more resin components in a solvent to create the adhesive formulation. The method includes applying the adhesive formulation to at least one of: a surface of the PVC, PVC containing, or PVC alloy, and the non-PVC surface. The method includes heating to activate the adhesive formulation. The heating may allow substantial evolution of hydrochloric acid (HCl) from the vinyl chloride (VC) monomer containing adhesive formulation at temperatures equal to or greater than 150° C.

The substantial evolution of HCl may be due to dehydrochlorination that may be caused by heating the PVC. The heating may occur at a temperature of 100° C. or less. The heating may occur at a temperature of substantially 93° C. The heating may occur for 5 minutes or less. The heating may occur for 1 minute or less. The substantial evolution of HCl may be sufficient to accelerate curing of the two or more resins. The substantial evolution of HCl may be insufficient to cause degradation of the PVC. The PVC may be part of a roof membrane.

The solvent may include a ketone. The solvent may include an aromatic solvent. The solvent may include an ether-based solvent. The two or more resin components may include at least one of an acrylic copolymer, terpolymer, and a component derived from reacting bisphenol A and epichlorohydrin. The adhesive formulation may bond the membrane to an induction plate such that separating the bonded membrane and induction plate may require applying a tensile pull-out force of at least 600 lbs. The two or more resin components may include Elvacite 4188, MC-39, and Epon 828. A concentration of Elvacite 4188 by volume in the adhesive formulation may be between 28 and 32%. A concentration of MC-39 by volume in the adhesive formulation may be between 7.0 and 8.0%. A concentration of Epon 828 by volume in the adhesive formulation may be between 1.25 and 1.75%. A concentration of solvent by volume in the adhesive formulation may be between 55 and 65%.

### BRIEF DESCRIPTION OF DRAWINGS

FIG. 1A shows a cross-section of roof structure/system 100 that includes several roof layers made of different materials according to aspects of the present disclosure.

FIG. 1B shows using a fastener 150 in a mechanical roof fastening system 100a according to aspects of the present disclosure.

FIG. 1C is a blow-up showing details of fastener 150 and related components.

FIG. 1D shows plate 160 and its relationship to fastener 150.

FIG. 1E shows application of fastener 150 and plate 160 to fasten roof 100 according to system 100a and aspects of the present disclosure.

FIG. 1F shows another step in the application of fastener 150 and plate 160 to fasten roof 100 according to system 100a after the step in FIG. 1E.

FIG. 1G shows another step in the application of fastener 150 and plate 160 to fasten roof 100 according to system 100a after the step in FIG. 1F.

FIG. 1H shows another step in the application of fastener 150 and plate 160 to fasten roof 100 according to system 100a after the step in FIG. 1G.

FIG. 1I shows application of roof 100 layers during installation according to aspects of the present disclosure.

FIG. 1J shows another step in the application of fasteners 150 and layer 140 to roof 100 during installation after the step shown in FIG. 1I.

FIG. 1K shows another step in the application of fasteners 150 and layer 140 to roof 100 during installation after the step shown in FIG. 1J.

FIG. 1L shows one issue that might be caused if fasteners 150 around the periphery of membrane portions 140 are the only mechanism holding membrane 140 to the roof 100.

FIG. 2A shows roof 100 with induction welding installation/fastening system 100b in place of mechanically fastening system 100a according to aspects of the present disclosure.

FIG. 2B shows a blow-up of the portion of the roof 100 including induction plate 260 and related components.

FIG. 2C shows an exemplary application of adhesive 270 to plate 260 and/or to membrane layer 140 according to aspects of the present disclosure.

FIG. 2D shows application of fastener 150 and plate 160 to fasten roof 100 according to system 100b and aspects of the present disclosure.

FIG. 2E shows a side view of FIG. 2D.

FIG. 2F shows another step in the application of fastener 150 and plate 260 to fasten roof 100 according to system 100b after the step in FIGS. 2D and 2E.

FIG. 2G shows another step in the application of fastener 150 and plate 260 to fasten roof 100 according to system 100b after the step in FIG. 2F.

FIG. 2H shows another step in the application of fastener 150 and plate 260 to fasten roof 100 according to system 100b after the step in FIG. 2G.

FIG. 2I shows application of roof 100 layers during installation according to aspects of the present disclosure.

FIG. 2J shows another step in application of fasteners 150 and layer 140 to roof 100 during installation using fastening system 100b after the step in FIG. 2I.

FIG. 2K shows another step in application of fasteners 150 and layer 140 to roof 100 during installation using fastening system 100b after the step in FIG. 2J.

FIG. 2L shows an alternative configuration to the configuration shown in FIG. 2K in which systems 100a and 100b are used together.

FIG. 3 presents measured values of tensile force required to separate fastener 150, plate 260, after adhering using adhesive 270a, from membrane 140 for certain experimental samples.

FIG. 4 presents measured values of tensile forces required to separate fastener 150, plate 260, after adhering using adhesive 270a or less adherent variations of this formula, from membrane 140.

FIG. 5 shows the results of the test sample prior to separating fastener 150 and plate 260 from membrane 140.

FIG. 6 shows the results of separating fastener 150 out of Plate number 3.

### DETAILED DESCRIPTION

### Roof System 100

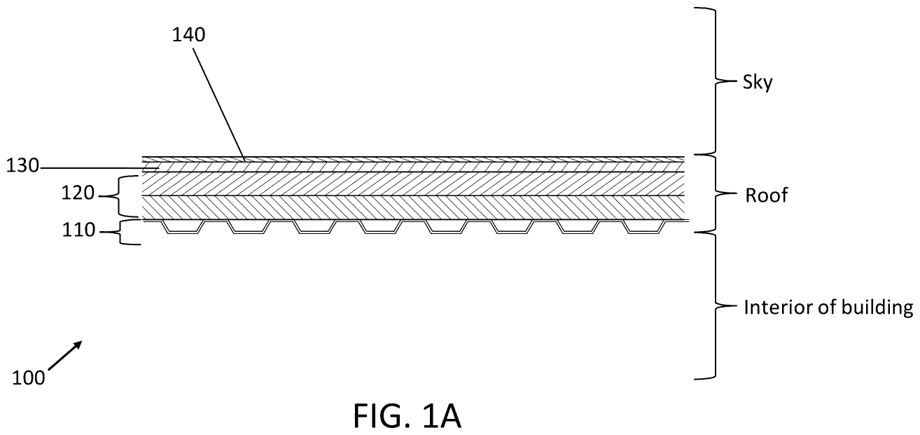

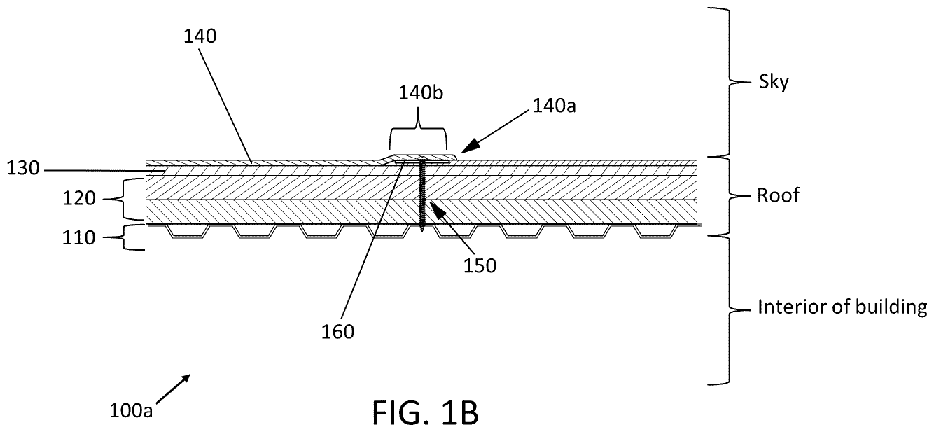

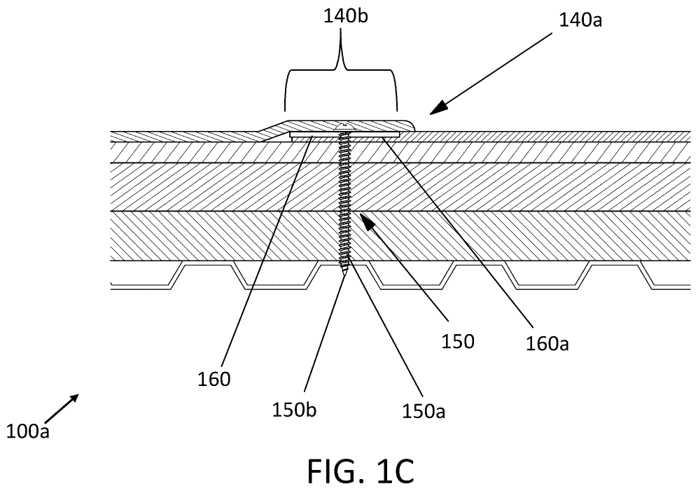

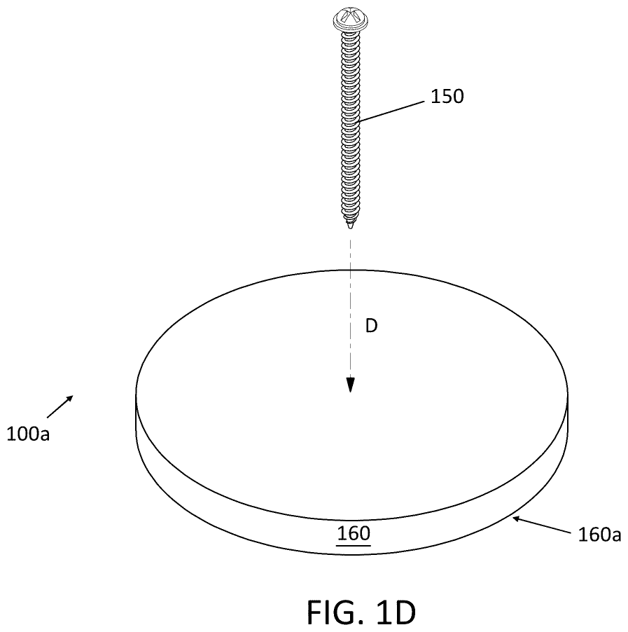

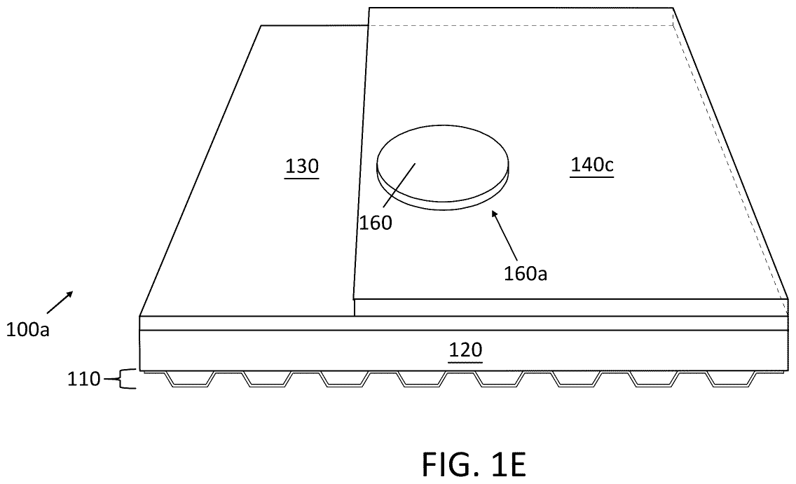

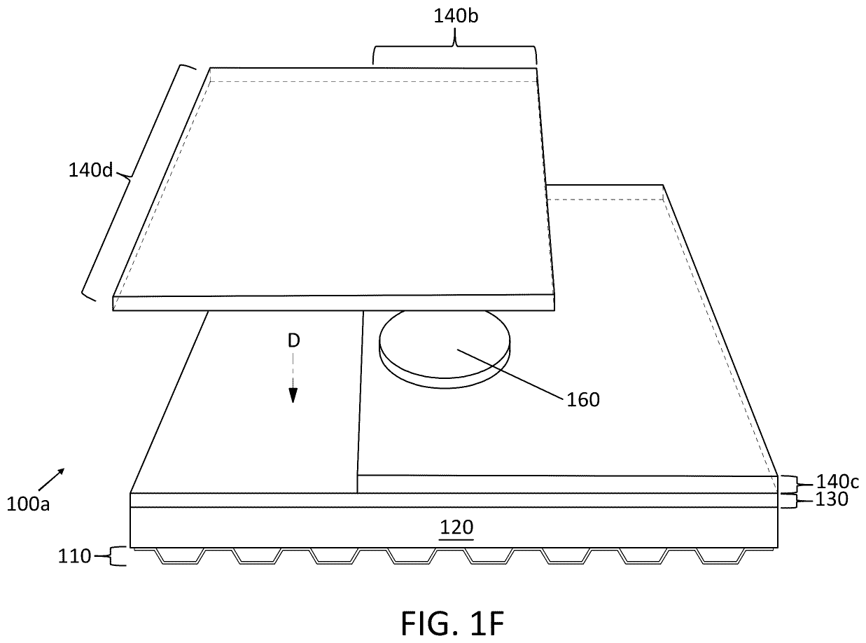

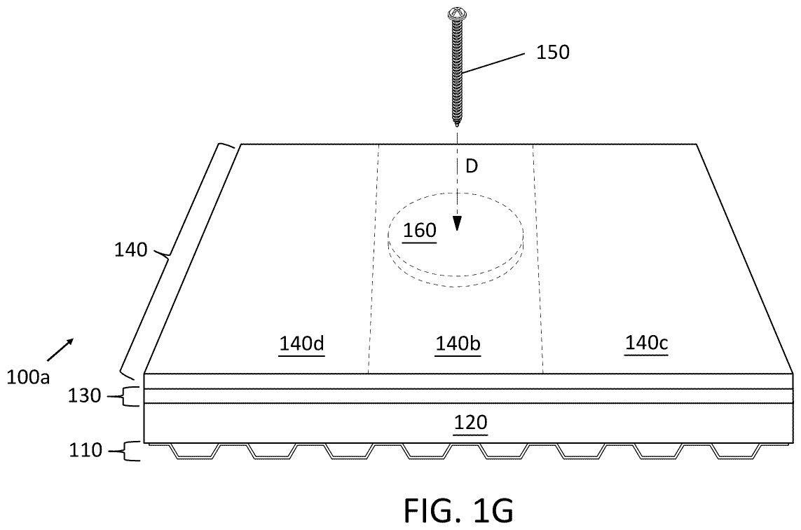

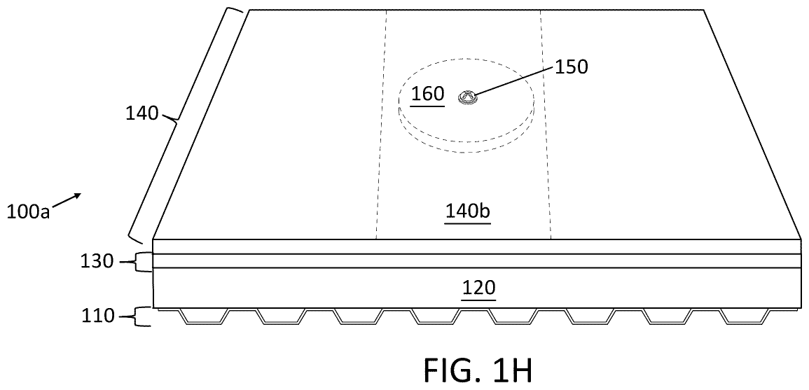

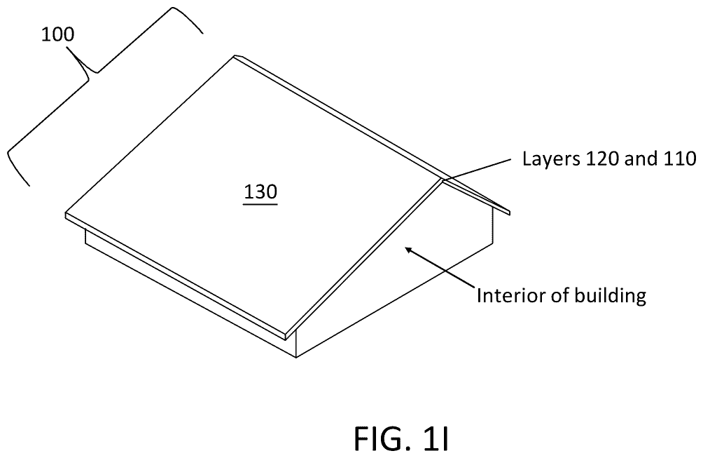

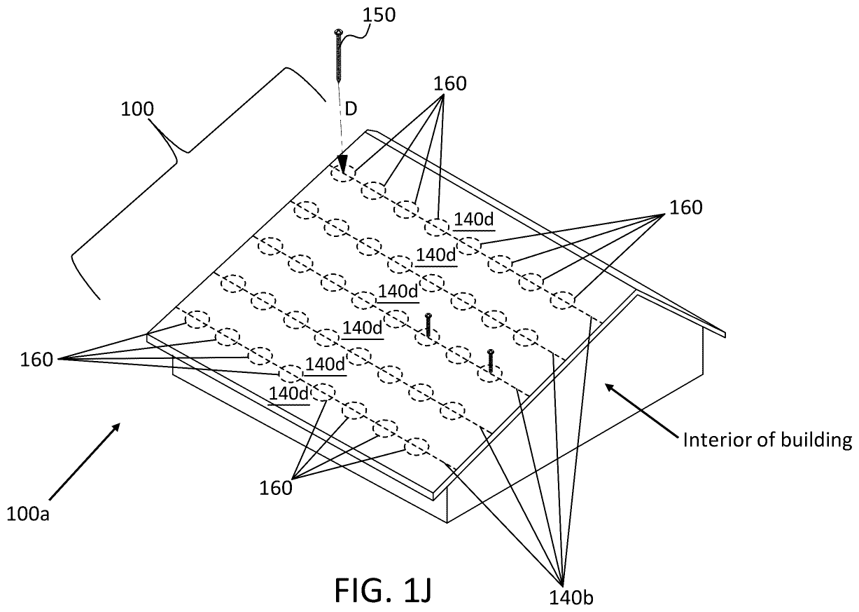

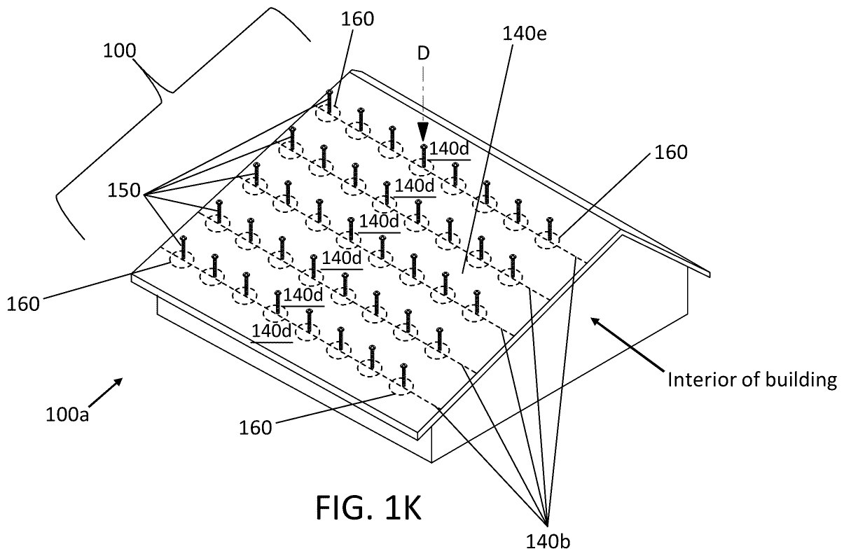

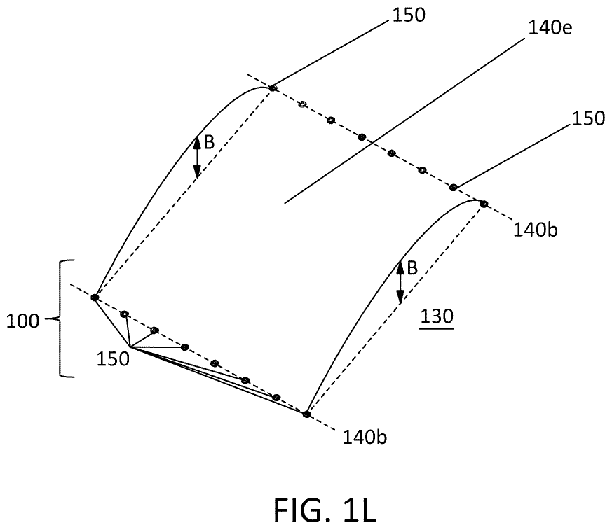

FIG. 1A shows a cross-section of roof structure/system 100 that includes several roof layers made of different materials. It is to be understood that, while FIG. 1A and related figures show layers that may be included in roof 100, this presentation is not meant to be exhaustive or limiting. For example, layers may be included in roof 100 in a different order or configuration than shown. Layers not shown in the figures may be added to roof 100 within the scope of the present disclosure.

As shown in FIG. 1A, roof 100 may include a framing structure 110, such as a steel roof deck. Layer 110 may be corrugated as shown in FIG. 1A. Alternatively, layer 110 may include a different type of corrugation than shown, lack corrugation altogether, and/or include another type of structure (e.g., a flat, sloped, or segmented structure). More generally, layer 110 may include any suitable type of material that can provide structural integrity to roof 100. Such materials may include various metals such as steel, aluminum, and metal alloys. Layer 110 may also include composite materials, such as carbon composites or other types of composites (e.g., fiberglass composites, aramid/synthetic composites, natural fiber composites wood composites, etc.).

Roof 100 may include an insulation layer 120. Layer 120 may be proximate to framing layer 110, as shown in FIG. 1A. Layer 120 may alternatively be placed at another suitable location within roof 100. Layer 120 may include a number of sub-layers of suitable insulating material(s). For example, insulation layer 120 may include one or more layers of polyisocyanurate insulation board. Layer 120 may include any of the following materials: fiberglass, mineral wool, cellulose, foam board, spray foam, reflective insulation, and natural fiber insulation (e.g., cotton, wool, or hemp). It is to be understood that insulation materials not expressly discussed herein may nevertheless be included in layer 120 in accordance with aspects of the present disclosure.

Another layer, cover layer 130, proximate to insulation layer 120 may be included. Layer 130 may be, for example, formed on top of layer 120 as shown in FIG. 1A. It may include a cover board or outer board made of metal (e.g., steel) or other structurally sound material. Other materials that may be included are boards or other structures made and/or including minerals or composites such as gypsum (CaSO₄·2H₂O), drywall, plaster, fiber cement board, MgO board, cement board, metal panels, wood paneling (e.g., components made from plywood or oriented strand board (OSB)), and prefabricated wall systems (e.g., systems including insulated concrete foams (ICFs)). It is to be understood that materials not expressly discussed herein may nevertheless be included in layer 130 in accordance with aspects of the present disclosure.

As shown in FIG. 1A, the top or outer layer 140 of the roof 100 can be a material that provides waterproofing and protection against the elements. Suitable materials for layer 140 include roofing membrane materials, e.g., polymeric (for example, PVC-containing) materials and/or woven materials. Layer 140 may include one or more single-ply membranes (e.g., thin, flexible sheets of synthetic (or similar) material applied to the roof surface as single layers) or multiple-ply membranes. Examples of membrane materials that may be used include PVC membranes, PVC containing membranes, alloys, and alloys with Ketone Ethylene Ester (KEE), and other suitable alloys and/or membranes, ethylene propylene diene monomer (EPDM) membranes, thermoplastic olefin (TPO) membranes, membranes made from blends of rubber and plastic, membranes made from vinyl polymers and plasticizers, bitumen membranes (e.g., modified bitumen membranes), asphalt-based roofing materials (unmodified or modified with polymers or other additives), liquid applied membranes (e.g., fluid-applied waterproofing materials applied as liquids and then cured), such as those made from polymer-modified asphalt, acrylic, or polyurethane compounds and applied using spray, brush, or roller methods, spray foam roofing, etc. Layer 140 may also include other forms of bitumen (e.g., in built-up roofing (BUR) systems), fiberglass, and polyester, among other things. It is to be understood that materials not expressly discussed herein may nevertheless be included in layer 140 in accordance with aspects of the present disclosure.

### Mechanical Fastening System 100a

To create a stable roof system, individual layers of roof 100 shown in FIG. 1A should be adhered or fastened together. FIG. 1B shows one way of doing this using a fastener 150 according to a mechanical fastening system 100a. FIG. 1C is a blow-up showing details of fastener 150 and related components.

Fastener 150 can be any suitable type of fastener, including mechanical fasteners such as screws, staples, nails, bolts, rivets, or other anchors. Fastener 150 is represented in FIGS. 1B and 1C as a screw with threads 150a. However, it is to be understood that this representation is merely exemplary and not intended to be limiting. Fastener 150 may be driven through roof 100 (e.g., via screwdriver, hammer, or pneumatic tool). When this happens, fastener 150 can engage (e.g., via threads 150a) with layers of roof 100 (e.g., layers 110, 120, 130, and 140). This engagement can be sufficient to hold the roof 100 layers together and to hold fastener 150 in place, as shown in FIGS. 1B and 1C. Such can effectively embed the tip 150b of fastener 150 in frame layer 110. In other words, driving fastener 150 into frame layer 110 can hold roof 100 together and provide structural integrity to the entire roofing system.

Fastener 150 may be made of any suitable type of material with sufficient structural integrity to perform its fastening function described above in the context of FIG. 1C and roof 100. Certain metals (e.g., hardened and/or carbon steel) may be preferred. Other suitable materials include stainless steel, brass, composites (e.g., any composite discussed herein), aluminum, copper, bronze, titanium, hardened or hard plastics, other steels, and zinc. Combinations of these materials may also be used. It is to be understood that materials not expressly discussed herein may nevertheless be included in fastener 150 in accordance with aspects of the present disclosure.

The fastening system 100a shown in FIG. 1B also includes a plate 160 that can assist in fastening layer 140 as well as other layers of roof 100. Plate 160 and its relationship to fastener 150 are shown in more detail in FIG. 1D. Plate 160 may have a lower surface including edge 160a with an adherence mechanism (not shown) that can clamp a portion of membrane 140a (see, e.g., representation of portion 140a in FIG. 1C) underneath it as fastener 150 is driven into the frame structure 110. The adherence mechanism may include, for example, teeth that engage with an underlying portion 140a of layer 140 exerting a downward pressure in the direction of frame layer 110. This can effectively sandwich portion 140a between plate 160 and lower roof 100 layers (e.g., layers 130 and 120). While teeth or similar barbed, engaging structures can provide an exemplary adherence mechanism for edge 160a, the adherence mechanism need not take the form of teeth. In fact, the sandwiching effect described here may be accomplished with an edge 160a that is smooth or flat. It will be appreciated that edge 160a, plate 160, and the adherence mechanism may take on other suitable forms (including those not expressly described herein) to perform the fastening function described above.

FIGS. 1E-1H show application of fastener 150 and plate 160 to fasten roof 100 according to system 100a. As shown in FIG. 1E, a first step is to assemble the lower portions of the roof (e.g., layers 110, 120, and 130). Subsequently, segment 140c, a portion of membrane layer 140, is placed on top of portions of layer 130, as shown. Then plate 160 is placed on top of portions of layer 130 and portion 140c where fastener 150 is to be driven. FIG. 1E shows edge 160a of plate 160 that overlaps with membrane segment 140c. Edge 160a may sandwich or hold portions of segment 140c, as described in the context of FIG. 1C above. Once fastener 150 is driven into roof 100, this sandwiching will help hold segment 140c on roof 100.

FIG. 1F shows application of a second segment 140d of membrane layer 140. As shown in the figure, segment 140d is placed such that it covers plate 160 and has a region of overlap 140b with portion 140c. The region of overlap 140b, as discussed in more detail below, is used to weld portions 140c and 140d of membrane layer 140 together to create a watertight seal. Segment 140d is lowered and placed on the roof 100 in direction D, as shown.

FIG. 1G shows fastening system 100a once both segments 140c and 140d of membrane layer 140 have been applied. At this point, plate 160 is fully covered by membrane layer 140, in particular its overlap region 140b. Because of this, plate 160 would not be visible from the vantage point in FIG. 1G. Therefore, plate 160 is represented by a dashed outline in the figure. At this point, fastener 150 is driven through membrane layer 140 as well as the rest of roof 100 (i.e., layers 130, 120, and 110). Doing this creates the fastened roof portion 100 shown in FIG. 1H.

After the fastening mechanism has been applied as shown in FIGS. 1G and 1H, the overlap portion 140b of the membrane layer 140 may be welded by any suitable method including by using a heat gun, wedge-shaped welding tool, resistive heating, or other suitable heating mechanism. Other options for adhering portions of membrane 140 include solvent bonding and gluing, as well as using other suitable adhesives and/or adhesion mechanisms. Welding membrane 140 can involve heating overlapping portions 140b and 140a to soften their thermoplastic material. This can allow portions of layer 140 to fuse together and form a watertight bond. This process can be repeated across major portions and/or the entirety of roof 100. During the process, plate 160 may adhere to the membrane 140 via heating/thermal welding. The same (or different) thermal welding process can also adhere the overlap portion 140b of the membrane 140 to the clamped portion 140a of the membrane.

FIGS. 1I-1K show application of fasteners 150 and layer 140 to roof 100 during installation. Note that FIGS. 1I-1K are meant to illustrate principles of roof installation and are not necessarily drawn to scale. In particular, fasteners 150 are depicted with an exaggerated size relative to the rest of roof 100 so that their placement and installation can be more easily visualized.

As shown in FIG. 1I, layers 110, 120, and 130 are installed on roof 100 such that layer 130 is exposed. This corresponds to the step shown in FIG. 1E, but before portion 140c and plate 160 are added. Note that, even though FIG. 1I shows layer 130 as a single layer with no seams, this is not meant to be limiting. Layer 130 may be installed in any suitable manner (e.g., as individual boards, strips, patches, or rolls, depending on the precise composition and properties of the materials in layer 130).

Next, as shown in FIG. 1J, individual strips 140d of membrane layer 140 are laid on the roof 100. Here again, the presentation is not meant to be limiting. Although layer 140 is shown in FIG. 1J as being applied in strips 140d, layer 140 may be applied in any suitable manner (e.g., as strips, segments, patches, or rolls). Layer 140 may be applied to the entire roof 100 as shown in FIG. 1J so as to provide a watertight layer to all portions of the roof 100. Alternatively, layer 140 may be applied to select portions (not shown) of roof 100 to waterproof and/or reinforce those select roof portions. Each segment 140d has a corresponding overlap/flap portion 140b next to its neighboring strip. This creates an overlap of layer 140 that facilitates a water-tight seal when heat is used to weld the overlaps, as described above. Before welding, however, fasteners 150 are driven through portion 140d and underlying layers 130, 120, and 110 (as shown, for example, in FIG. 1B). As shown in FIG. 1B, the positions where fasteners 150 are driven into the roof 100 may correspond to the locations of plates 160. This is also shown in FIG. 1J. It is to be understood that, while plates 160 are shown only along a portion of 140b for a particular strip 140d, such plates can be aligned as shown with all portions 140b to provide adherence of that portion using fasteners 150. Although only one fastener 150 is shown in FIG. 1J, it is to be understood that multiple fasteners 150 are used to adhere membrane 140 (i.e., along seams 140b).

FIG. 1K more comprehensively shows installation of multiple fasteners 150 into layer 140 to adhere that layer to the rest of roof 100. More specifically, as shown in FIG. 1K, fasteners 150 are driven through the overlap 140b, plates 160, and the rest of the roof layers through to the frame layer 110 (see FIG. 1C). As described above, this causes the layers of roof 100 to adhere to one another. As shown in FIG. 1K, fasteners 150 may be spaced periodically along or throughout roof 100 to create a relatively uniform adherence of layer 140. The precise spacing and/or number of fasteners 150 employed in this step may vary and depend on such factors as the size (e.g., width and length) of roof 100, the placement of strips 140d of layer 140, and the placement of layers underneath layer 140 (i.e., layers 110, 120, and 130). Subsequent to the driving of fasteners 150 into roof 100, heat is applied (e.g., at the location of each of the plates 160) by any of the manners described herein. The heat softens the polymer material in the membrane layer 140 to weld the overlaps 140b shut. This can seal the roof 100 so that it is watertight.

As discussed above, the installation shown in FIGS. 1I-1K can exhibit problems with water infiltration. This is particularly true if welding of flaps 140b is incomplete and/or if there are compromises of the membrane material in layer 140. Any perforation or hole, even small pin holes, either inherent in layer 140 or left by the installation process, can create substantial water ingress problems for the entire roof 100, not just layer 140. Since the above-described installation method uses fasteners 150 to adhere membrane layer 140 by puncturing that layer, it naturally creates areas of potential weakness or deficiency in waterproofing. That is, if/when either welding of flap or the seal created by plate 160 with membrane portions 140a and 140b are incomplete or faulty, water will likely seep through the membrane layer 140 at some point in the lifetime of roof 100. Even if there is no installation fault in these areas, wear and exposure to the elements may cause them to open up over time.

Additionally, membrane 140 may be adhered to roof 100 only via fasteners 150 along portion 140b, which is typically along a periphery of a section of membrane 140. This means that portions of membrane 140 that are spaced apart from portions 140b (e.g., portion 140e shown in FIG. 1K) may not necessarily be fastened tightly to roof 100 over their surface, at least not by fasteners 150. Yet having portions of membrane 140 (e.g., portion 140c) that are not tightly adhered to the roof could cause issues.

FIG. 1L illustrates exemplary issues that might be caused if fasteners 150 around the periphery of membrane portions 140 are the only mechanism holding membrane 140 to the roof 100. In particular, as shown in FIG. 1L, space B between membrane 140 and insulation 130 (or other portions of roof 100) could allow moisture or leaks to infiltrate roof 100. More generally, air or wind may infiltrate space B. If that happens, portions 140e may be lifted by that air to create a disadvantageous billowing effect shown in FIG. 1L. These and other problems can be addressed via induction welding fastening system 100b discussed below.

### Induction Welding Fastening System 100b

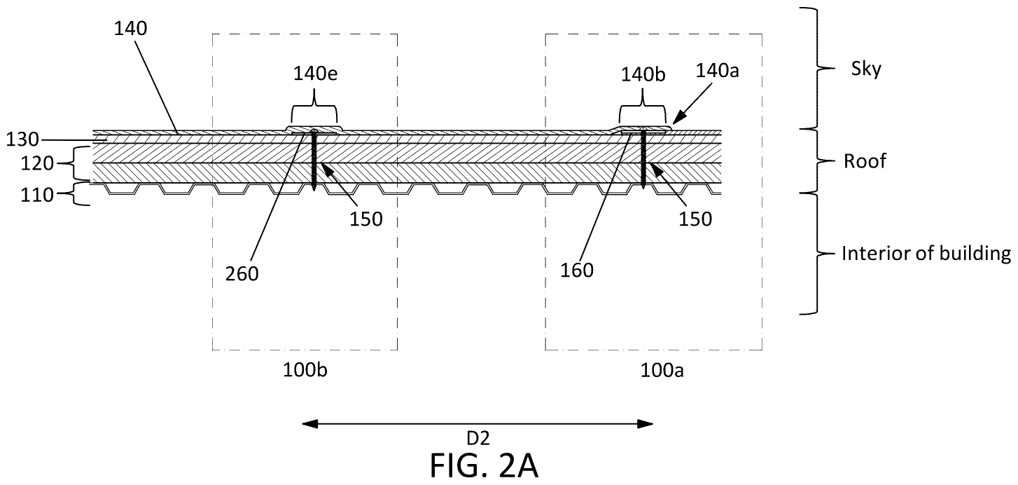

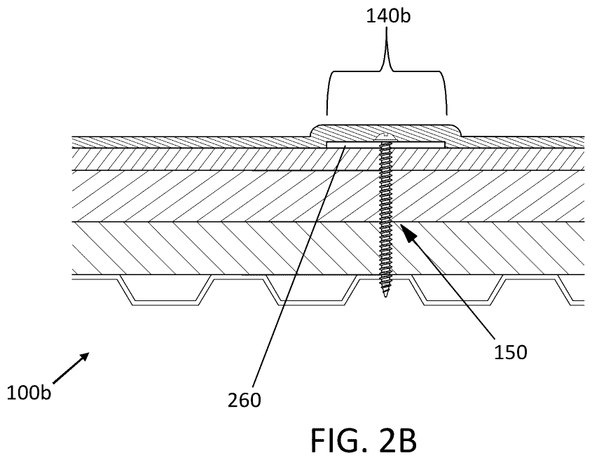

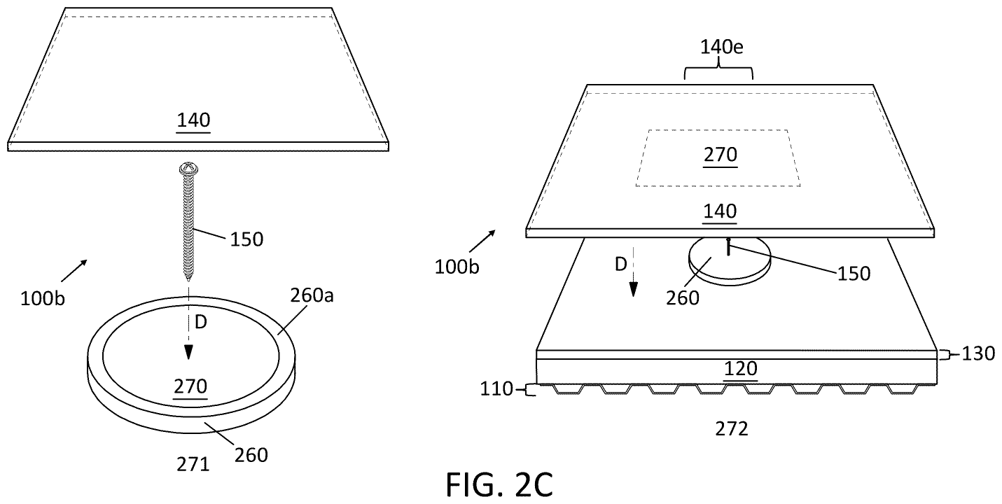

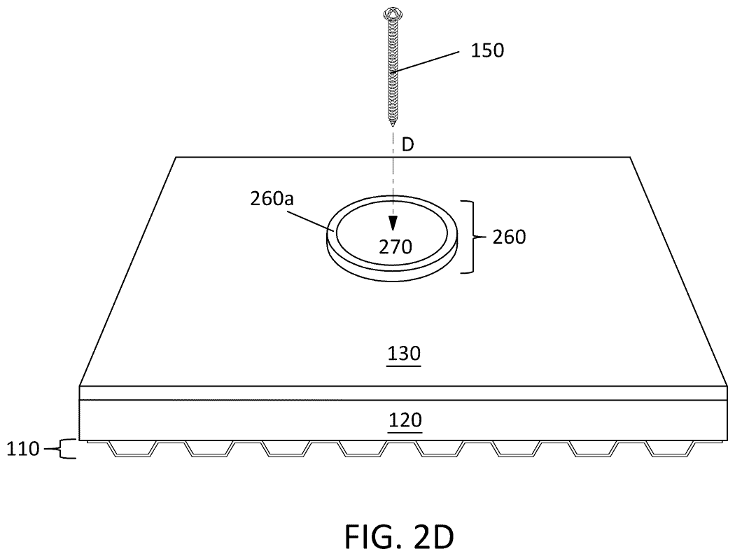

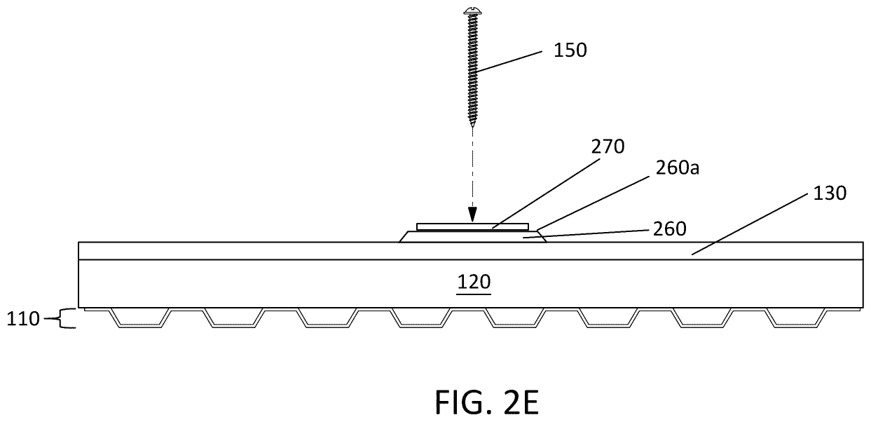

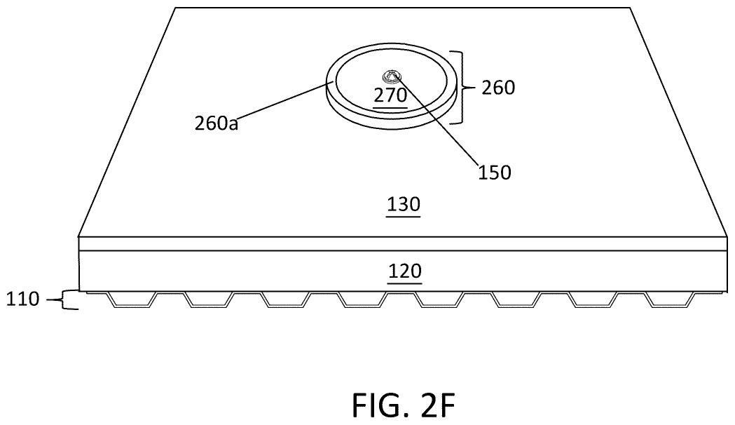

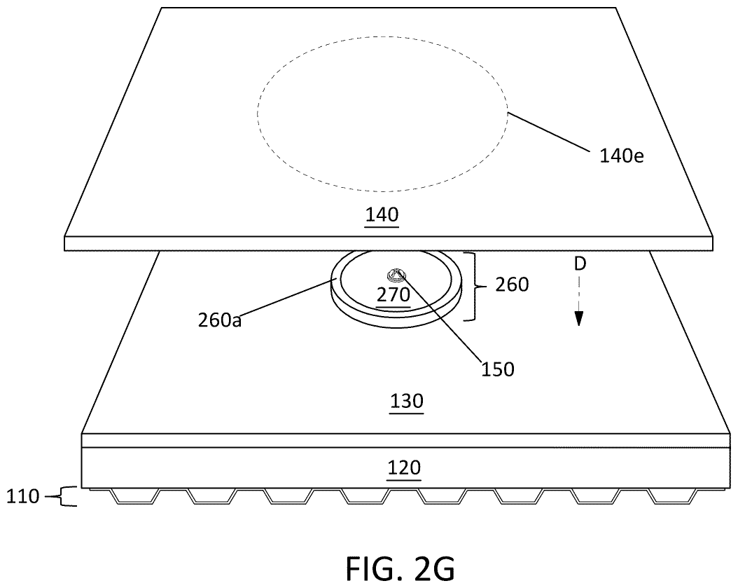

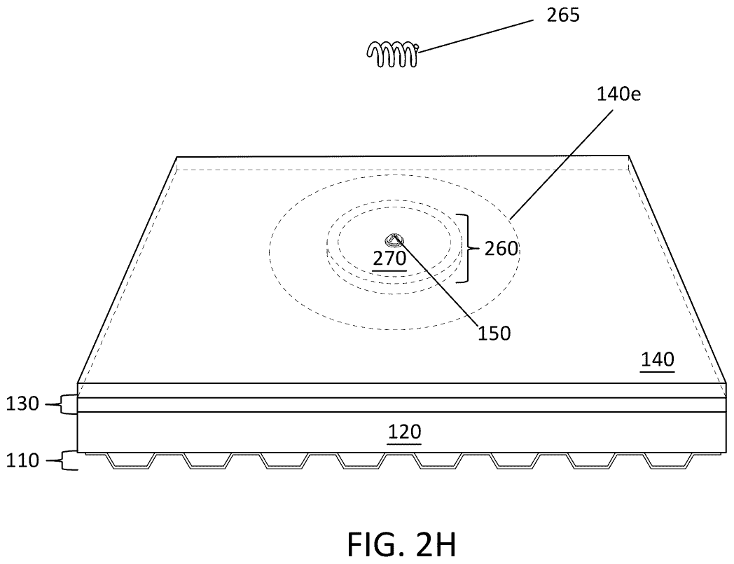

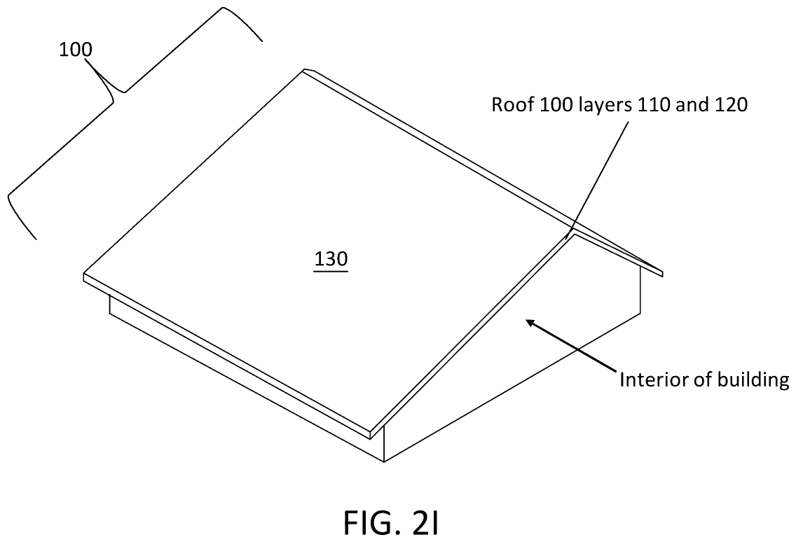

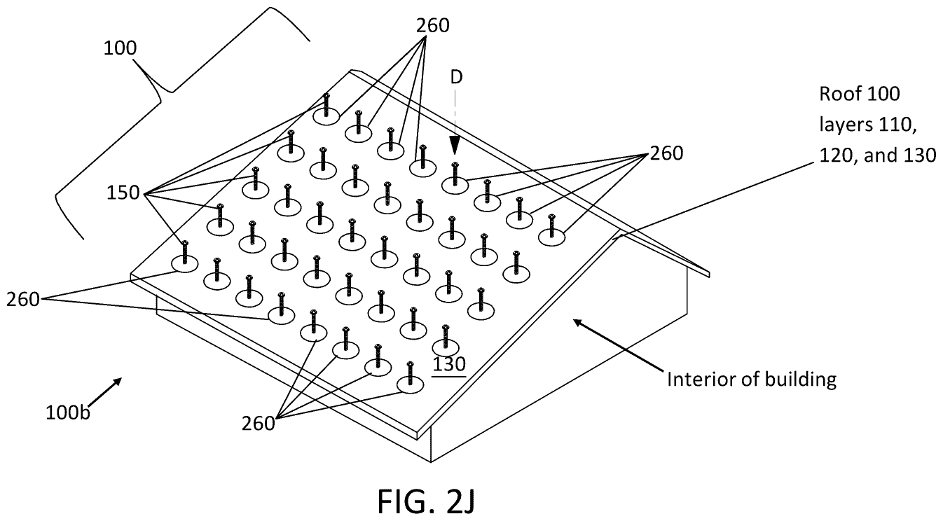

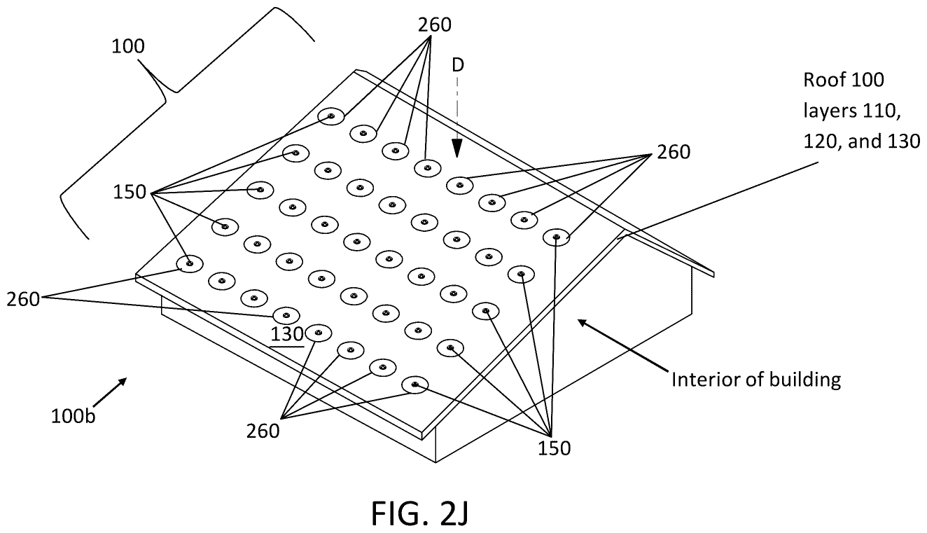

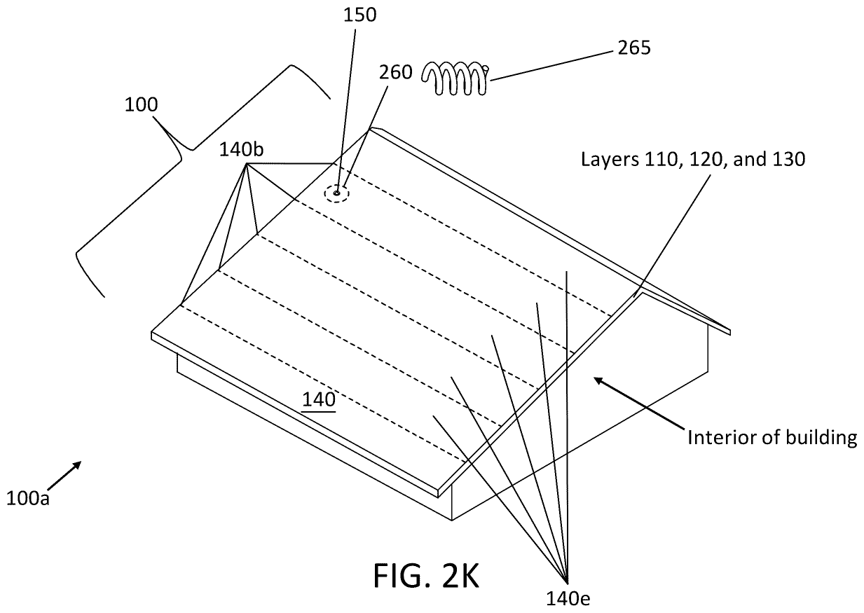

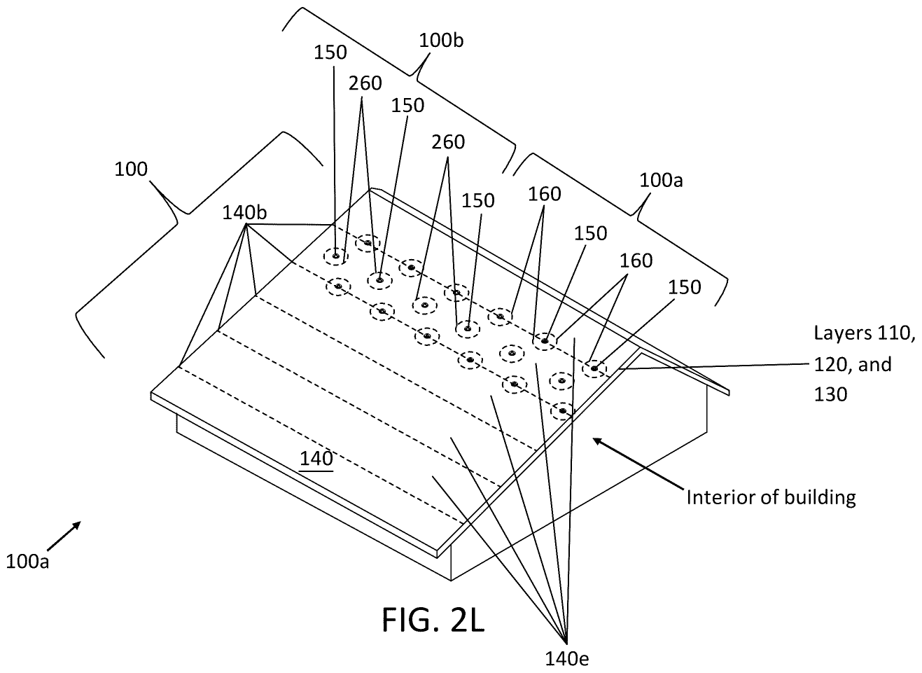

FIG. 2A shows the same roof 100 but with modified installation/fastening system 100b installed in addition to mechanically fastening system 100a. As shown in FIG. 2A, system 100b is spaced a distance D2 from system 100a. System 100a, as discussed above, may be placed on portions 140b to hold sections of membrane 140d in place on roof 100. System 100b is designed to hold portions of membrane 140 spaced apart from sections 140b (e.g., portion 140e shown in FIG. 1K) to the roof to prevent problems (e.g., water ingress, air lift, and billowing discussed above in the context of FIG. 1K) due to insufficient adherence.

It is noted that systems 100a and 100b can be used essentially interchangeably. In other words, it is possible to use fastening system 100a in more portions of roof 100 than shown in FIG. 2A and FIGS. 1J and 1K (i.e., around the periphery of a portion of membrane 140). More specifically, it is possible to place fastening mechanism 100a such that it adheres portion 140e to roof 100 to prevent the billowing effect shown in FIG. 1L and to decrease space B between membrane 140 and roof 100. That is, it is possible to place system 100a in the locations discussed below for system 100b when system 100a is used in the role of adhering portions 140c to roof 100. In a similar way, is possible to use fastening system 100b in place of system 100a to secure the periphery of a portion of membrane 140 (i.e., along portion 140b) rather than an interior portion. This is effectively replacing system 100a in FIGS. 1D-1K with system 100b. In the latter case, system 100b would be installed on portion 140b as described below. Although FIG. 2A shows systems 100a and 100b being used together, this need not be the case. A roof 100 could be installed using only system 100a as the fastening mechanism. Alternatively, roof 100 could be installed using only system 100b as the fastening mechanism.

Unlike system 100a, system 100b uses induction heating to enhance fastening and sealing of membrane layer 140. More specifically, system 100b includes induction plate 260 that can direct and focus heating more precisely on portions of membrane 140 than can the heating methods used in mechanical fastening system 100a. This can improve roof sealing and adhesion through targeting and focusing localized heating of portions of membrane layer 140, among other things. FIG. 2B shows a blow-up of the portion of the roof 100 (analogous to FIG. 1C) including induction plate 260 and related components.

As shown in FIGS. 2A and 2B, the induction system 100b uses nearly all of the same components as mechanical system 100a. Common components used by both systems may include: fastener 150, membrane 140, board 130, insulation 120, and frame 110. System 100b differs principally from system 100a in that it replaces mechanical plate 160 with induction plate 260. Components other than plate 260 function the same way in system 100b as described for system 100a in the context of FIGS. 1A and 1B. Yet installation of roof 100 components in the induction system 100b differs somewhat from installation for the mechanical system 100a described in FIGS. 1I-1K. The differences are described below.

The installation differences relate primarily to a difference between induction plate 260 and plate 160. Induction plate 260 is designed to heat locally using electromagnetic induction. Specifically, plate 260 includes elements that will resistively heat when exposed to an alternating electromagnetic (E/M) field. The E/M field can be applied to the plate 260 once installed (e.g., as in FIG. 2A). This causes local heating of the plate 260 in a relatively focused way, i.e., such that the heating source is actually the plate itself. It focuses heat on portions of the membrane layer 140 in the vicinity of plate 260 (e.g., portions 140a, 140b, and 140e) as well as on the adhesive on plate 260. This heating can be used to activate or weld membrane layer 140 when it is made of thermoplastic roofing membrane, such as those made of PVC, PVC containing materials, and/or Thermoplastic Olefin (TPO), for example, and many of the other materials described or suggested herein. Therefore, heating plate 260 using E/M induction can bond membrane layer 140 to create a seamless and watertight roof surface. The process is relatively well controlled such that overall heating temperatures can be more precise and localized with less collateral thermal stressing than in the case of system 100a. Suitable heating temperatures can be between 400° C. and 600° C. As shown in FIG. 2B, this can lead to a contiguous area 140e of membrane layer 140 over fastener 150. In other words, induction heating can be used to install a roof without puncturing the membrane layer 140 and without creating seams in that layer that are vulnerable to degradation. Since the process does not require puncturing or creating seams in membrane layer 140, that layer 140 may even potentially be installed as a single sheet.

Adhesive 270 is a heat-activated adhesive that may be used to adhere induction plate 260 to membrane layer 140 in a number of different ways. Two such exemplary applications of adhesive 270 (i.e., cases 271 and 272) are shown in FIG. 2C. In case 271, one or more surfaces of plate 260 may be coated with adhesive 270 as shown. Alternatively, adhesive 270 may be applied to the underside of membrane layer 140 in the vicinity of portion 140b where layer 140 overlaps with plate 260. This is shown as case 272 in FIG. 2C. Either way, when plate 260 and layer 140 are brought together, they will adhere with the help of adhesive 270. It should be appreciated that applying adhesive 270 according to case 271 and 272 can be functionally equivalent in terms of assembling roof 100. The precise location of the application of adhesive 270 is not particularly important to many such applications. Moreover, adhesive 270 can also be applied to both components 260 and 140 in a way that utilizes both cases 271 and 272 concurrently (i.e., where adhesive 270 coats both plate 260 and layer 140). Any of the above treatments would adhere plate 260 to membrane layer 140 within the teachings of the present disclosure.

More generally, adhesive 270 may be applied to any portion of membrane layer 140 or any other polymeric/PVC containing component to adhere that component to another portion of roof 100 within the context of the present disclosure. Adhesive 270 may also be applied to any component of roof 100 that is to be adhered to a portion of membrane layer 140. Adhesive 270 may also be applied to both the roof 100 portion and the membrane layer 140 portion. While the following description focuses on specific applications of adhesive 270 described herein, it should be understood that this presentation is not meant to be limiting. Potential uses for adhesive 270 include applications beyond these specifically presented examples. Such uses should be considered within the scope of the present disclosure.

FIG. 2C shows the application of adhesive 270 to a top edge 260a of induction plate 260. Such an application of adhesive 270 can facilitate adherence of induction plate 260 directly to portions 140b and 140e of membrane layer 140. Coating other portions of induction plate 260 to facilitate adherence of the plate 260 to other portions of membrane 140 may be advantageous and should be considered within the scope of the present disclosure. For example, any surface of induction plate 260 may be coated with adhesive 270, including every surface shown in FIG. 2C. Moreover, for both simplicity of application of adhesive 270 and to increase adhesion, among other purposes, the entire induction plate 260 may be coated.

As discussed above, adhesive 270 may be heat activated. Suitable heat activated adhesives include those that are PVC- or vinyl chloride (VC) copolymer-based, polyurethane-based, polyamide-based, or polyester-based. Typical activation temperatures are 400° C.-600° C. For example, an alternating E/M field may be applied to induction plate 260. As discussed above, induction plate 260 can be endowed with materials that will respond to the E/M field by creating eddy currents that resistively heat the plate. In this configuration, heating the plate activates the adhesive 270 by heating the adhesive. Once suitably heated, adhesive 270 then adheres the induction plate 260 to the portions 140b and/or 140e (or other portion) of membrane layer 140. This process can be conducted with a single membrane without creating holes in that membrane, thus preserving water-tight capabilities. FIG. 2B, in particular, shows how membrane 140 covers induction plate 260 and fastener 150 without a scam or hole. This process requires driving the fastener 150 into the frame 110 prior to addition of the membrane 140.

FIGS. 2D-2H show application of fastener 150 and plate 260 to fasten roof 100 according to system 100b. As shown in FIG. 2D, a first step is to assemble the lower portions of the roof (e.g., layers 110, 120, and 130). Subsequently, plate 260 is placed on layer 130 where fastener 150 is to be driven. FIG. 2D also shows edge 260a of plate 260 that overlaps with membrane portions 140b and 140c.

FIG. 2D shows application of adhesive 270 in case 271 (FIG. 2C). FIG. 2E shows a side view of the configuration shown in FIG. 2D. However, it is to be understood that case 272 applying adhesive to membrane layer 140 can be used in this step to generate similar results in terms of roof 100 assembly. In either case, adhesive 270 may be any adhesive described or suggested herein. The application of adhesive 270 to plate 260 or layer 140 in cases 271 and 272 is not meant to be exhaustive. Adhesive 270 may be applied in any suitable manner for roof 100 assembly to any of the components of roof 100.

FIG. 2F shows fastening system 100b once fastener 150 has been driven into roof 100, specifically into layers 130, 120, and 110. As shown in the figure, fastener 150 in system 100b is driven through these layers before membrane layer 140 is applied. Again, this means that fastener 150 does not puncture or perforate membrane layer 140. In such cases, layer 140 need not be applied in segments like 140c and 140d, as in the case of system 100a. Here membrane layer 140 may even be applied as a single sheet. This can ensure that, once applied, membrane layer 140 is relatively intact and more effective at water or moisture resistance. On the other hand, fastener 150 is driven through layers 130, 120, and 110 similarly as in the case of system 100a. Thus, driving fastener 150 through these layers should adhere them to one another, as discussed above in the context of system 100a. This creates the adhered fastener system 100b configuration shown in FIG. 2B, but without the addition of membrane layer 140.

More particularly, FIG. 2G shows application of membrane layer 140 to fastening system 100b. As shown in FIG. 2G, membrane layer 140 can be attached as a single layer. Portion 140c of membrane layer 140 is placed over induction plate 260. This placement can align portion 140c with adhesive 270. Doing so creates the sandwich configuration shown in FIG. 2H. Note that, in FIG. 2H, both plate 260 and adhesive 270 are shown with dotted lines because they are covered by membrane layer 140. In addition, the end of fastener 150 (black dot shown in FIG. 2G) is also covered by portion 140e of membrane layer 140.

After the fastening mechanism has been applied as shown in FIG. 2G, the portion 140e of the membrane layer 140 may be welded onto plate 260 by any suitable method described herein. For example, welding portions 140e can involve heating induction plate 260 by applying E/M radiation to induction plate 260, as described above. In one example, E/M radiation is provided by coil 265 shown symbolically in FIG. 2H or any other suitable device. Other suitable devices for applying E/M radiation include solenoids, other coils, generators, magnets, and transformers. It is to be understood that any device that can generate a suitable amount of E/M radiation may be used whether such device is expressly described herein or not. The heating through plate 260 may activate adhesive 270. Once activated, adhesive 270 can bond portion 140e to plate 260. This bonding can adhere membrane layer 140 to the rest of roof 100. In this way, system 100b bonds membrane 140 to roof 100 without substantially puncturing or perforating membrane layer 140. As discussed above, this can avoid compromising the waterproofing role of layer 140. For the same reasons, it can avoid problems associated with wear and aging discussed above in the context of system 100a.

During this welding process, a number of other steps may be taken. For example, overlapping seams (analogous to 140b and 140a in the context of system 100a) may be welded (e.g., partially welded) using the induction heating properties of plate 260. This can also be accomplished by other means, e.g., with a hot air gun or wedge-shaped welding tool. Either way, the heating softens the thermoplastic material of layer 140, allowing it to fuse together and form a watertight bond. This process may be repeated across roof 100. The same (or other) welding processes can also adhere other portions of membrane layer (e.g., overlap portion 140b shown above in the context of system 100a).

FIGS. 2I-2K show application of fasteners 150 and layer 140 to roof 100 during installation using fastening system 100b. Note that FIGS. 2I-2K are meant to illustrate principles of roof installation and are not necessarily drawn to scale. In particular, fasteners, 150 are depicted with an exaggerated size relative to the rest of roof 100 so that their placement and installation can be more easily visualized. Also, for ease of presentation, FIGS. 2I-2K depict application fastening system 100b only (rather than a combination of systems 100a and 100b, as shown in FIG. 2A). This is because system 100b can be used with or without system 100a. That said, it is to be understood that one way of employing systems 100a and 100b is to include system 100a to fasten membrane 140 to roof 100 is to use system 100a to fasten the periphery (e.g., as shown in FIGS. 2A and 1L) and system 100b to fasten other portions of the membrane 140e. It is to be understood that uses of systems 100a and 100b described herein are merely exemplary and other configurations not described, shown, or implied herein are possible and within the scope of this disclosure.

As shown in FIG. 2I, layers 110, 120, and 130 are installed on roof 100 such that layer 130 is exposed. Note that, even though FIG. 2I shows layer 130 as a single layer with no seams, this is not meant to be limiting. Layer 130 may be installed in any suitable manner (e.g., as individual boards, strips, patches, or rolls, depending on the precise composition and properties of the materials in layer 130).

Next, as shown in FIG. 2J, is the installation of multiple fasteners 150 into layers 110, 120, and 130. That is, FIG. 2J shows the same roof configuration as in FIG. 2I, but with fasteners 150 driven into plates 260 and the rest of the roof 100. The purpose is to adhere the roof 100 layers together to create a cohesive roof structure in advance of the application of membrane layer 140. More specifically, fasteners 150 are driven through the roof layers 130, 120, and 110 (see FIGS. 2A and 2B). As described above, this causes the roof 100 layers to adhere to one another. It also drives fasteners 150 through a respective plate 260, potentially fixing the plates in the roof structure. As shown in FIG. 2J, fasteners 150 may be spaced periodically along or throughout roof 100 to create a relatively uniform adherence of layers 110, 120, and 130. The precise spacing and/or number of fasteners 150 employed in this step may vary and depend on such factors as the size (e.g., width and length) of roof 100, the placement of plates 260, and the placement of layers 110, 120, and 130.

FIG. 2K shows placement of membrane layer 140 on the roof. Notably, membrane layer 140 is placed over fasteners 150. This creates portions 140e in the vicinity of fasteners 150 and plates 260 that cover these components. For this reason, plate 260 shown in FIG. 2K is represented by a dashed outline. The dashed outline indicates that plate 260 is under membrane layer 140. It is to be understood that there are multiple fasteners 150 and plates 260 in roof 100 in FIG. 2K that underlie membrane 140 and, therefore, would not be visible from the vantage point in that figure.

Subsequent to the driving of fasteners 150 into roof 100 and the addition of membrane 140, heat may be applied. For example, heat may be generated at the location of each of the plates 260 (shown in FIG. 2K via dashed outline because it would be obscured by membrane 140 from the vantage point shown in the figure) through application of E/M radiation, as described above. This is represented schematically in FIG. 2K by the presence of coil 265 which, as described above, can provide E/M radiation to plates 260. This causes the plates 260 to heat activate the adhesive 270. Activating the adhesive chemically bonds portion 140e to plates 160. It may also melt or weld other portions of membrane layer 140, as described above. In any case, heat activating the adhesive 270 can help seal the roof structure 100 from the elements (e.g., make the roof 100 watertight). Even where this bonding of 140 to plate 260 does not make the roof watertight, it creates a greater number of bonding points without increasing penetration points. Welding/bonding the overlapping seams can create watertightness.

Although layer 140 is shown in FIG. 2K as being applied as a single layer, layer 140 may be applied in any suitable manner (e.g., as strips, segments, patches, or rolls). Layer 140 may be applied to the entire roof 100 as shown in FIG. 2K so as to provide a watertight layer to all portions of the roof 100. Alternatively, layer 140 may be applied to select portions (not shown) of roof 100 to waterproof and/or reinforce those select roof portions. In any case, each portion 140e can correspond to an array of fasteners 150 and plates 260. This creates periodic points of adherence of layer 140 to the rest of roof 100 across the roof.

FIG. 2L shows an alternative configuration to that shown in FIG. 2K using both systems 100a and 100b simultaneously. The configuration shown in FIG. 2K is similar to that shown in FIG. 2A, but for the entire roof 100. In particular, FIG. 2L shows system 100a used to adhere sections of membrane 140 at its periphery (i.e., near or around portions 140b, as described in the context of FIGS. 1J and 1K above). At the same time, the configuration shown in FIG. 2L anchors, adheres, or fixes portions 140e using the induction welding method discussed above in the context of system 100b.

The installation of roof 100 shown in FIGS. 2I-2L using fastening system 100b can exhibit superior water resistance and resistance to the elements than the installation shown in FIGS. 1I-1K using system 100a. This is, at least in part, due to the ability of system 100b to install membrane layer 140 to roof 100 without puncturing or perforating membrane layer 140. That said, the strength of the waterproofing in this configuration is directly dependent on the strength of the bond between the adhesive 270 and the plates 260/membrane 140. The stronger the adhesive bond, the better the watertight seal.

### PVC Adhesive 270

Several different kinds of adhesives and adhesive blends can be used as adhesive 270 in the above described inductive heating fastening system 100b. Specific compositions are discussed below including a new formulation, adhesive 270a, that improves plate 260/membrane 140 bonding strength.

Many types of adhesives 270 for membrane layer 140 will incorporate an adhesive known to bond PVC, a major component of many roof membrane layers 140. Such adhesives are specialized in the sense that they contain solvents or chemical compounds that are directed toward specific aspects of PVC that implicate bonding strength. These aspects include thermal stabilizing components that can prevent chemical degradation of PVC during heating, as well as certain solvents or compounds that soften PVC surfaces to allow them to adhere and form a strong bond with other surfaces as the solvent evaporates.

Examples of PVC adhesives that may be used as adhesive 270 include PVC cement (a mixture of solvents, such as tetrahydrofuran (THF) or methyl ethyl ketone (MEK), and PVC resin particles), PVC welding adhesive, also known as PVC welding solvent or PVC welding glue, PVC contact adhesive, also known as PVC contact cement (a rubber-based adhesive used for bonding PVC materials to various substrates, such as wood, metal, or concrete), PVC construction adhesive, PVC sealant, and PVC vinyl adhesive.

### Problems With PVC Adhesives: Thermal Stabilization

Overall, PVC can chemically degrade when exposed to heat. This can lead to degradation of its structure, physical properties, and appearance. Understanding the mechanisms of thermal degradation is essential for controlling processing conditions, selecting appropriate additives and stabilizers, and ensuring the performance and longevity of PVC materials in various applications. The breakdown of PVC when exposed to heat occurs through several mechanisms, including the following.

Dehydrochlorination: At elevated temperatures, PVC undergoes dehydrochlorination, a process where hydrogen chloride (HCl) gas is released from the polymer chains. This leaves sites in the PVC polymer backbone unsaturated and causes loss of chlorine atoms. This process weakens the polymer structure and can lead to chain scission.

Chain Scission: High temperatures can cause the polymer chains in PVC to break apart, leading to the breaking of polymer chains (i.e., chain scission). As the polymer chains degrade, the molecular weight of the PVC decreases, resulting in a reduction in mechanical strength, flexibility, and other physical properties of the material.

Cross-Linking: In addition to chain scission, thermal degradation of PVC can also lead to cross-linking, where adjacent polymer chains form covalent bonds between each other. Cross-linking can occur through various mechanisms, such as radical reactions or condensation reactions, and results in the formation of a three-dimensional network structure within the polymer matrix. Cross-linking can alter the properties of PVC, making it harder, more brittle, and less thermoplastic.

Discoloration: Thermal degradation of PVC can also result in color changes and discoloration of the material. As PVC breaks down, it may undergo chemical reactions that produce colored or discolored by-products, leading to changes in the appearance of the material. In particular, this can lead to “browning” or “burning” where the appearance of the PVC becomes darker and more brown.

Release of Volatile Organic Compounds (VOCs): During thermal degradation, PVC may release VOCs and other gases, including HCl, vinyl chloride (VC), and other by-products. The release of VOCs can contribute to odor, air pollution, and potential health hazards in the surrounding environment.

Thermal stabilizers are additives used in PVC, VC containing copolymers, and adhesive formulations containing PVC or VC containing copolymers to prevent or minimize degradation of the polymer during processing and exposure to heat. They help maintain integrity of the formulation and/or material containing the chlorinated polymers and extend service life. Several types of thermal stabilizers are commonly used in PVC and PVC adhesive formulations. Examples include the following stabilizers. Most adhesives 270 mentioned above employ one or more of these stabilizers.

Lead-Based Stabilizers: Historically, lead-based stabilizers, such as lead salts of carboxylic acids or organotin compounds, were commonly used in PVC and VC containing copolymer formulations due to their thermal stability and effectiveness as stabilizers. However, due to environmental and health concerns, their use has been phased out or restricted in many applications.

Calcium/Zinc Stabilizers: Calcium/zinc stabilizers are a popular alternative to lead-based stabilizers in PVC and VC containing copolymer formulations. They typically include calcium and zinc salts of carboxylic acids or other organic acids. Calcium/zinc stabilizers provide effective thermal stabilization while offering improved environmental and health profiles compared to lead-based stabilizers.

Tin Stabilizers: Organotin compounds, such as dibutyltin dilaurate (DBTDL) or dioctyltin maleate (DOTM), are used as thermal stabilizers in PVC and VC containing copolymer formulations. Tin stabilizers offer good heat stability and weather resistance and are often used in outdoor applications such as PVC pipes, window profiles, and roofing membranes.

Barium/Cadmium Stabilizers: Barium and cadmium salts of carboxylic acids or other organic acids are used as thermal stabilizers in PVC and VC containing copolymer formulations. However, the use of cadmium-based stabilizers has declined due to environmental and health concerns associated with cadmium.

Mixed Metal Stabilizers: Mixed metal stabilizers combine various metal compounds, such as calcium, zinc, magnesium, and barium, to achieve optimal thermal stabilization properties. These stabilizers offer a balance of performance, cost-effectiveness, and environmental compatibility.

Organic Stabilizers: Organic compounds, such as epoxidized soybean oil (ESO), phosphites, or hindered phenols, are used as co-stabilizers or secondary stabilizers in PVC formulations. These organic stabilizers enhance the thermal stability of PVC and VC containing copolymers and complement the primary stabilizers.

Mixed metal thermal stabilizers, in particular, are additives in thermally processed formula containing vinyl chloride monomers such as PVC, a VC copolymer formula, or some combination thereof. When polymers containing vinyl chloride monomers are thermally processed, they can partially or fully dehydrochlorinate releasing varying quantities of HCl, which is reactive and corrosive. Furthermore, dehydrochlorination at one oganochloride site facilitates dehydrochlorinations at adjacent sites along the polymer backbone. This can lead to a catalytic cascade of degradation and concomitant HCl evolution. As discussed above, this can compromise the polymer backbone, degrade the polymer, or degrade or alter other components in the formula in other ways. Therefore, thermal stabilizers for dehydrochlorination can, under certain conditions, enable safe processing of PVC and VC containing copolymers at elevated temperatures by chemically capturing and quenching HCl molecules before they can degrade desirable properties.

While thermal stabilizers may stave off chemical degradation of VC containing or copolymers in membrane layer 140 during induction heating and activation of adhesive 270, they can also introduce several problems. Those problems include slowing or arresting cross linking and/or curing of the adhesive 270. This can happen, for example, because the thermal stabilizers may consume excess HCl that can play a role in curing the adhesive 270. In that case, the adhesives 270 with thermal stabilization for dehydrochlorination can cure incompletely or insufficiently. This can degrade the strength of bonding between plate 260 and membrane layer 140.

### Improved Adhesive Composition 270a

According to aspects of the present disclosure, an improved adhesive 270a is provided. More specifically, the improved adhesive composition 270a uses a novel combination of chemical mechanisms to generate its full adhesive strength. It avoids some of the problems discussed above, particularly the problem of partial or incomplete adhesive curing due to excess HCl. It does so by deliberately excluding a thermal stabilizer for dehydrochlorination, previously viewed as an essential component for adhesive 270. Removing the thermal stabilizer for dehydrochlorination is thought to increase an amount of HCl in the adhesive system that improves cross-linking and/or curing of adhesive 270a.

More particularly, the improved adhesive 270a is a solvent-based thermal-activated chemo-triggered hot melt adhesive formulation. It can be coated onto induction plates 260 and/or other components in the roofing system 100 (e.g., membrane layer 140). When adhesive 270a-coated induction plates 260 are used in fastening system 100b, the coated plates 260 also function as a non-penetrating fastening method to affix roof membrane layer 140 to the underlying layers (i.e., layers 130, 120, and 110).

### Solvent S for Improved Adhesive 270a

Adhesive 270a is a multi-resin formulation. It can be prepared by dissolving its resin components in a suitable organic solvent S. Acceptable solvents include ketones such as acetone, methyl ethyl ketone (MEK, C₄H₈O), methyl isobutyl ketone (MIBK, (CH₃)₂CHCH₂C(O)CH₃), cyclohexanone (C₆H₁₀O), isophorone (C₉H₁₄O), and similar solvents. Still other suitable solvents include ether-based solvents such as tetrahydrofuran (THF, (CH₂)₄O), diethyl ether ((C₂H₅)₂O), dioxane (C₄H₈O₂), diglyme, also known as bis(2-methoxyethyl) ether (C₆H₁₄O₃), ethylene glycol dimethyl ether, also known as glyme (C₆H₁₄O₃), tetrahydropyran (THP, C₅H₁₀O) and similar solvents. Still other suitable solvents include aromatic solvents such as toluene, ethanol, isopropanol, methanol, ethyl acetate, hexane, chloroform, xylenes (e.g., ortho-xylene, meta-xylene, and para-xylene). The solvent S for adhesive 270a may include any of these solvents and/or any suitable combination of these solvents.

### Resin Components of Improved Adhesive 270a

Any suitable acrylic resin component may be used for adhesive 270a. Suitable examples include, but are not limited to the following. Elvacite™ (Elvacite) 4188 may be used. Elvacite 4188 is a product name for a grade of acrylic resin manufactured by Mitsubishi Chemical Group. Acrylic resins like Elvacite 4188 are thermoplastic copolymers derived from acrylic, methacrylic, or its derivatives. In addition, MC-39 may be used as a resin component in adhesive 270a. MC-39 is another thermoplastic copolymer derived from VC, vinyl acetate, and maleic acid or its derivatives. Other suitable resins that may be used in adhesive 270a include Epon™ (Epon) 828, which is a trademarked product name for a specific type of epoxy resin. Epon 828 is manufactured by Hexion, Inc. It is commonly used in combination with curing agents, such as amine-based or anhydride-based hardeners, to form cured epoxy systems with properties tailored to the desired application.

### Exemplary Adhesive 270a Formulations

The following are some exemplary adhesive 270a formulations that were found to be suitable for induction welded fastening system 100b. This listing of formulations is not meant to be exhaustive. It is to be understood that components and their proportions may be varied substantially and still remain within the scope of the present disclosure.

Adhesive 270a may include a mixture of three resin components, labeled A, B, and C for convenience. Resin component A may, for example, include an acrylic copolymer with an acid number ≥7.5, a glass transition temperature (T_{g}) between 50° C. ±20° C., and a molecular weight of 50,000-150,000 g/mol. One suitable example is Elvacite 4188 mentioned above. Resin component B may include terpolymers, copolymers used in the production of coatings, adhesives, and other specialty materials. These include polymers based on vinyl chloride, vinyl acetate, maleic acid, and/or maleic anhydride. They more specifically include, for example, terpolymers combining vinyl chloride and vinyl acetate with maleic acid (e.g., UCAR VMCA, VMCC, VMCH resins or similar analogs). They may include other terpolymers synthesized through copolymerization or terpolymerization processes. They may also include additional monomers to, for example, achieve specific metal adhesion properties such as acrylic acid, methacrylic acid, itaconic acid, maleic acid, maleic anhydride, bis(2-methacryloxyethyl phosphate, 2-(Methacryloxy) ethyl phosphate, 4-methacryloxyethyltrimellitic anhydride, and monoacryloxyethyl phosphate. The resulting copolymers or terpolymers when used in adhesive 270a can exhibit a combination of properties derived from the individual monomers, making them suitable for various applications in coatings, adhesives, and specialty materials. One example includes MC-39 mentioned above. The third resin component C may include a bisphenol A-epichlorohydrin copolymer crosslinker. An example includes Epon 828 mentioned above or suitable version of an epoxy modified Bisphenol A, Bisphenol F, or Bisphenol S resins with a viscosity of 1000-20,000 centipoise (cP).

The relative ratio of resin components A, B, and C as well as solvent S can vary in adhesive 270a formulations. One exemplary formulation appears below in Table 1.

TABLE 1
Exemplary formulations of adhesive 270a.

| | | Percentage in |
|---|---|---|
| Adhesive | | adhesive formula |
| Element ID | Component | (% by mass) |
| A | Elvacite 4188 | 30.0 |
| B | MC-39 | 7.5 |
| C | Epon 828 | 1.5 |
| S | Solvent (e.g., ketone, aromatic, etc.) | 61.0 |

With regard to the above components, A and B are thermally activated adhesives with carboxylate functionalities having good metal adhesion and compatibility with PVC. Component C is an epoxy resin with good metal adhesion that can covalently bond to amines, carboxylic acids, anhydrides, hydroxyls, or other nucleophilic moieties when catalyzed or thermally activated to form a crosslinked thermoset.

After applying the formulation for adhesive 270a to plate 260 or membrane layer 150 (or other component of roofing system 100), adhesive 270a can be dried in an oven at a temperature sufficient to evaporate solvent S and consolidate the formula as a non-tacky, hard, well-adhered film with full coverage over the surface 260a (e.g., as shown in FIG. 2C). This heat treatment can be performed at a low enough temperature (e.g., ˜93° C.) for longer periods of time (e.g., ≤10 minutes) or higher temperatures (e.g., ˜200° C.) and for a short enough duration (e.g., ≤10 seconds) so that there is no need for the PVC thermal stabilizer discussed above. Under these conditions, dehydrochlorination is kept at a negligible level even without a thermal stabilizer for dehydrochlorination.

When exposed to a powerful enough E/M field, as described above, the surface of plate 260 heats up. The surface coating of adhesive 270a and adjacent roof membrane 140e experience this high temperature. The temperature may be as high as, for example, 400° C. or greater for a short period of time (e.g., ≤10 seconds). At these elevated temperatures, it is assumed that some level of dehydrochlorination happens, particularly given the absence of a thermal stabilizer for dehydrochlorination. Released HCl molecules can be assumed to be free to roam through the molten polymer adhesive 270a and interact with chemical species at the interface between adhesive 270a, metallic plate 260, and the membrane surface 140e. Epoxy moieties may include a thermal stabilizer (e.g., a secondary thermal stabilizer). In this case, the free roaming acidic HCl molecules will likely protonate the Lewis basic epoxy group. It may be assumed that protonation by the HCl molecules catalyze the epoxy resin crosslinkers with the reactive moieties throughout the adhesive 270a, membrane surface 140e, and metal plate surface 260. The available reactive groups found across and throughout these interacting surfaces may be: epoxies, labile organochloride, unsaturated sites, carboxylic acids, carboxylic anhydrides, and hydroxyl groups. Cooling to room temperature creates a strong irreversible thermoset between these components.

### Results-Weld Strength

The strength of the weld between the improved adhesive 270a and plate 260 was measured. More specifically, a sample was prepared that reproduces fastener 150 and induction weld plate 260, with a testable variant of adhesive 270 penetrating through a piece of coverboard 120 over corrugated steel deck 110; coverboard 120 and steel deck 110 or sized to be handled (e.g., a square ranging in size from 1-3 square feet). An approximately one square foot piece of test membrane 130 was inductively welded to plate 260. After welding, the sample was allowed to cool for about 1 hour. Subsequently, coverboard 120 and steel panel 110 were manually twisted away from the fastener. This left exposed fastener 150 with its head mechanically trapped between plate 260 and the membrane 140. Membrane 140 was fixed to a tensile testing machine and the threaded end of fastener 150 was grasped in the opposing actuated jaws of the tester. Tensile strength of adhesive was measured by pulling adhered plate 260 from the membrane portion 140e at a rate of approximately 51 mm/min following Testing Application Standard (TAS) 117(B)-95.1. Eight adhered samples were tested to have a high level of confidence in the reported values.

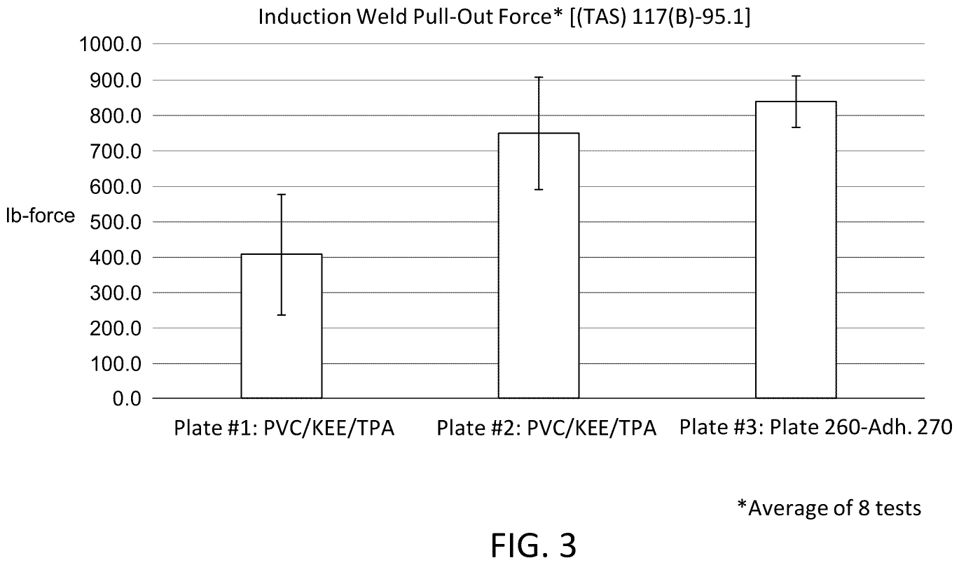

FIG. 3 presents measured values of the tensile force required to separate the fastener 150, and plate 260 from membrane 140, which may be, for example, a 36 mm nominally thick FiberTite™ single-ply roofing membrane manufactured by the Seaman Corporation, of Wooster Ohio. More particularly, FIG. 3 shows the tensile strength of the improved adhesive formulations 270a vs. those of commercial plates using other PVC, PVC containing, and PVC compatible adhesive formulations.

Plates Nos. 1 and 2 are commercial plates from two different manufacturers that are specified for use on PVC, PVC/KEE, and TPA (Tripolymer Alloy: another market designation for PVC blended membranes). Plate Number 3 replaced the commercial adhesive on Plate 1 with improved adhesive 270a. In the case of these experimental trials, improved adhesive 270a coated onto plate 3 was a blend of the two adhesive polymers and the epoxy crosslinker without a thermal stabilizer for dehydrochlorination.

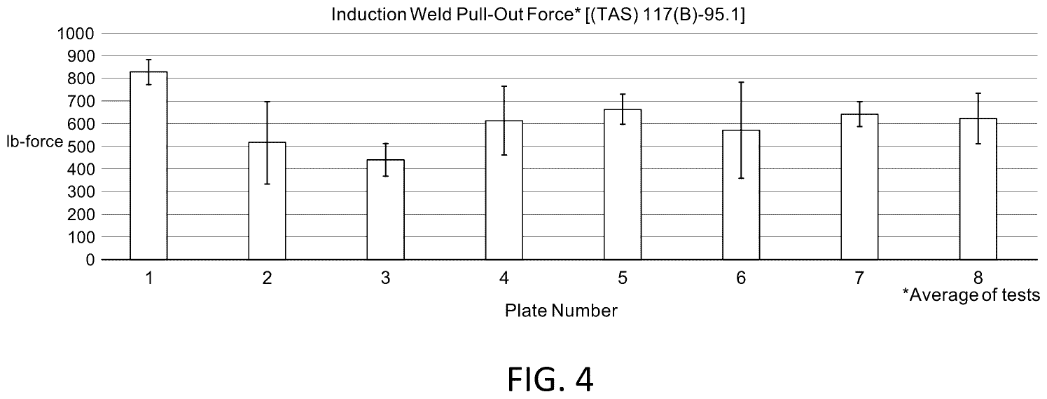

FIG. 4. shows the tensile strength of improved adhesive 270a vs. those of alternate experimental formulations. Table 2 (below) provides a specific description of each of the samples in FIG. 4. Note that the plates used to create FIG. 4 were different than those used to create FIG. 3 (i.e., plates 1-3 in FIG. 4 are not the same as plates 1-3 in FIG. 3.

TABLE 2
specific description of the samples
whose test results appear in FIG. 4.

| Plate No. | Details of adhesive formulation coating plate 260 in |
|---|---|
| (FIG. 4) | experimental trial |
| 1 | Elvacite 4188 + MC-39 + Epoxy Resin (thermal stabilizer |
| | omitted) |
| 2 | Elvacite 4188 + MC-39 + Epoxy Resin (thermal stabilizer |
| | included) |
| 3 | Elvacite 4349 + MC-39 + Epoxy Resin (thermal stabilizer |
| | included) |
| 4 | Elvacite 4188 (thermal stabilizer omitted) |
| 5 | MC-39 (thermal stabilizer omitted) |
| 6 | Elvacite 4188 + MC-39 (thermal stabilizer omitted) |
| 7 | Elvacite 4188 + Epoxy Resin (thermal stabilizer omitted) |
| 8 | MC-39 + Epoxy Resin (thermal stabilizer omitted) |

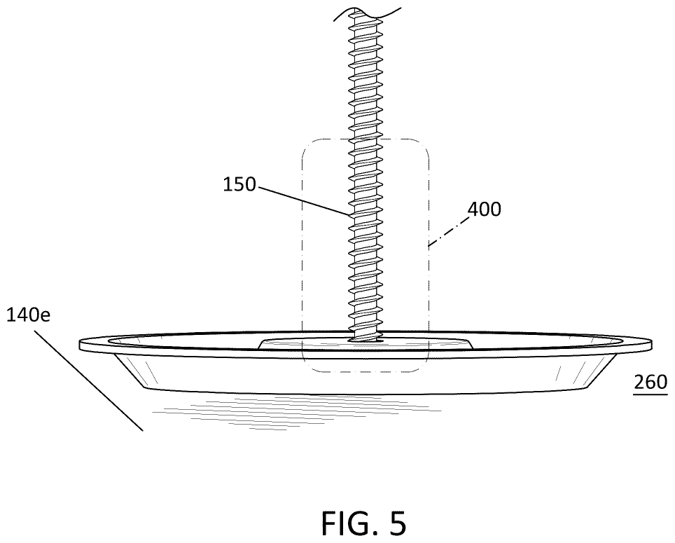

FIG. 5 is a photograph of Plate Number 3 (FIG. 4) before it is subjected to the testing graphically represented in FIG. 3. In particular, area 400 shows fastener 150 mechanically trapped by its head between plate 260 and membrane surface 140e.

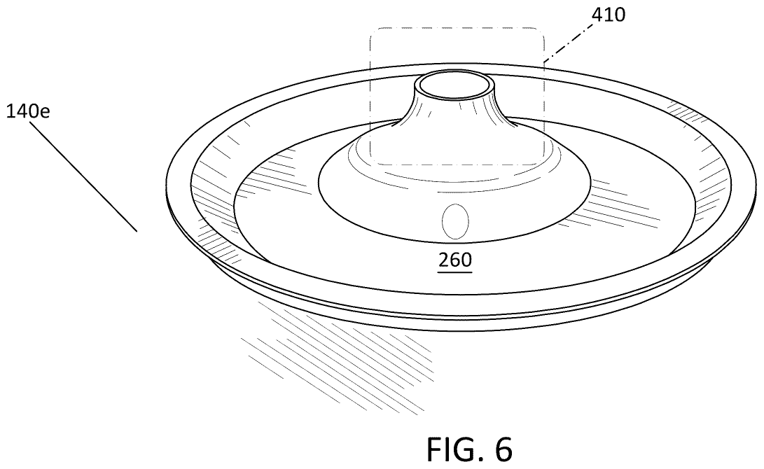

FIG. 6 is a photograph of plate number 3 after being subjected to Testing Application Standard (TAS) 117(B)-95.1. In particular, element 410 in FIG. 6 shows how the test caused plate 260 to exhibit a phenomenon referred to as “bottle capping.” Bottle capping occurs when pull-out of fastener 150 actually forces fastener 150 through the metal of plate 260 instead of rupturing the bond created by adhesive 270a. As shown, this substantially deformed the metal of plate 260. The result demonstrates the relative strength of improved adhesive 270a. More particularly, FIG. 6 shows how the preferred mode of failure for the plate 260/fastener 150 system is for the fastener 150 to be pulled completely out of its mechanical engagement with plate 260, requiring severe damage to plate 260. It indicates the bond created by adhesive 270a between membrane layer 140 and plate 260 is stronger than engagement of the fastener 150 with plate 260, as well as the strength of the metal itself. It represents an ideal mode of failure where the waterproofing membrane layer 140 is adhered to plate 260 with substantially greater force than can be provided by mechanical fastener 150 alone in system 100a. In other words, the bond of the adhesive 270a to the plate 260 is stronger even than the inherent properties of the metal of plate 260. This mode of failure can be considered to be indicative of a high welded bond strength that is interacting completely (or near completely) around the circumference of plate 260 and adhesive 270 with membrane surface 140e. This could represent, for example, between 800-900 pounds (lb) of force for the particular grade and thickness of steel used to manufacture plate 260. Adhesion for adhesive 270 to membrane surface 140c can be measured by using a stronger or thicker variant of plate 260.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. An adhesive formulation for adhering polyvinyl chloride (PVC) to non-PVC surfaces, comprising:
two or more resin components; and
a solvent for dissolving the two or more resin components, wherein the adhesive formulation, once applied to the PVC or alloyed PVC, allows substantial evolution of hydrochloric acid (HCl) from the VC monomer containing adhesive formulation at temperatures equal to or greater than to 150° C.

2. The adhesive formulation of claim 1, wherein the substantial evolution of HCl is due to dehydrochlorination caused by heating the adhesive formulation.

3. The adhesive formulation of claim 2, wherein the heating occurs at a temperature of 100° C. or less.

4. The adhesive formulation of claim 3, wherein the heating occurs at a temperature of 95° C. or less.

5. The adhesive formulation of claim 4, wherein the heating occurs at a temperature of substantially 93° C.

6. The adhesive formulation of claim 2, wherein the heating occurs for 5 minutes or less.

7. The adhesive formulation of claim 6, wherein the heating occurs for 1 minute or less.

8. The adhesive formulation of claim 1, wherein the substantial evolution of HCl is sufficient to accelerate curing of the two or more resins.

9. The adhesive formulation of claim 1, wherein the substantial evolution of HCl is insufficient to cause degradation of the PVC.

10. The adhesive formulation of claim 9, wherein insufficient to cause degradation of the PVC comprises that the HCl does not cause substantial browning of the PVC.

11. The adhesive formulation of claim 1, wherein the substantial evolution of HCl comprises allowing some to all of the stoichiometrically available HCl to evolve from the VC monomer containing adhesive.

12. The adhesive formulation of claim 1, wherein, when applied, the adhesive formulation bonds PVC to metal such that separating the bonded PVC and metal requires applying a tensile pull-out force of at least 400 lbs.

13. The adhesive formulation of claim 12, wherein, when applied, the adhesive formulation bonds PVC to metal such that separating the bonded PVC and metal requires applying a tensile pull-out force of at least 600 lbs.

14. The adhesive formulation of claim 13, wherein, when applied, the adhesive formulation bonds PVC to the metal such that separating the bonded PVC and metal requires applying a tensile pull-out force of at least 800 lbs.

15. A method of applying an adhesive formulation for adhering polyvinyl chloride (PVC), PVC containing, or PVC alloy to a non-PVC surface, comprising:
dissolving two or more resin components in a solvent to create the adhesive formulation;
applying the adhesive formulation to at least one of:
a surface of the PVC, PVC containing, or PVC alloy; and
the non-PVC surface; and
heating to activate the adhesive formulation, wherein the heating allows substantial evolution of hydrochloric acid (HCl) from the vinyl chloride (VC) monomer containing adhesive formulation at temperatures equal to or greater than 150° C.
